(19) United States
(12) Patent Application Publication
(10) Pub. No.: US 2008/0268214 A1
(43) Pub. Date: Oct. 30, 2008

(54) Decorative safety glass

(76) Inventors: Richard Allen Hayes, Beaumont, TX (US); Rebecca L. Smith, Vienna, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/796,856

(22) Filed: Apr. 30, 2007

(51) Int. Cl. B32B 7/00; B05D 5/10; G03G 7/00

(52) U.S. Cl. 428/210; 427/207.1; 428/195.1

(57) ABSTRACT

An image-bearing article comprising a film layer bearing an image and a polymeric interlayer sheet comprising an ionomer copolymer of an alpha-olefin and about 15 to about 30 wt % of an alpha, beta-ethylenically unsaturated carboxylic acid based on the total weight of the ionomer copolymer, wherein about 5 to about 90 percent of the carboxylic acids are neutralized with one or more metal ions. In addition, a process of preparing an image-bearing article comprising an image-bearing film layer and an ionomer interlayer sheet:
(a) providing a film layer;
(b) printing an image on the film layer so as to produce an image-bearing film layer containing an image-bearing side; and
(c) laminating an ionomer interlayer sheet to the image-bearing side of the image-bearing film layer.

Preferably the film layer is coated on the image-bearing side and over the image with an adhesion promoter.

### FIELD OF THE INVENTION

The present invention relates to image-bearing safety glass articles, preferably image-bearing solar control safety glass articles.

### BACKGROUND OF THE INVENTION

Glass laminated products have contributed to society for almost a century. Beyond the well known, every day automotive safety glass used in windshields, laminated glass is used in all forms of the transportation industry. It is utilized as windows for trains, airplanes, ships, and nearly every other mode of transportation. Safety glass is characterized by high impact and penetration resistance and does not scatter glass shards and debris when shattered. Safety glass typically consists of a sandwich of two glass sheets or panels bonded together with an interlayer of a polymeric film or sheet, which is placed between the two glass sheets. One or both of the glass sheets may be replaced with optically clear rigid polymeric sheets, such as sheets of polycarbonate materials. Safety glass has further evolved to include multiple layers of glass and polymeric sheets bonded together with interlayers of polymeric films or sheets.

The interlayer is typically made with a relatively thick polymer film or sheet, which exhibits toughness and bondability to provide adhesion to the glass in the event of a crack or crash. Over the years, a wide variety of polymeric interlayers have been developed to produce laminated products. In general, these polymeric interlayers must possess a combination of characteristics including very high optical clarity, low haze, high impact resistance, high penetration resistance, excellent ultraviolet light resistance, good long term thermal stability, excellent adhesion to glass and other rigid polymeric sheets, low ultraviolet light transmittance, low moisture absorption, high moisture resistance, excellent long term weatherability, among other requirements.

Widely used interlayer materials utilized currently include complex, multicomponent compositions based on poly(vinyl acetal) (preferably poly(vinyl butyral) (PVB)), polyurethane (PU), polyvinylchloride (PVC), linear low density polyethylenes (preferably metallocene-catalyzed), poly(ethylene-co-vinyl acetate) (EVAc), polymeric fatty acid polyamides, polyester resins, such as poly(ethylene terephthalate), silicone elastomers, epoxy resins, elastomeric polycarbonates, ionomers (neutralized ethylene acid copolymer which comprises copolymerized residues of ethylene and copolymerized residues of α,β-unsaturated carboxylic acid) and the like.

An area of societal need is the reduction of energy consumption within the structure, such as an automobile or building, to which the glass is attached. One manner that this need has been met is through the use of films which absorb or reflect near infrared and infrared energy. For example, the air conditioning load in the summer may be reduced in buildings, automobiles and the like equipped with solar control windows which block out a portion of the near infrared region of the solar spectral range.

Solar control films which absorb the infrared light and convert the energy to heat are known and typically incorporate infrared-absorptive nanoparticles. To preserve the clarity and transparency of the substrate, these materials need to have nominal particle sizes below about 50-200 nanometers (nm). Film substrates coated with antimony tin oxide (ATO) and indium tin oxide (ITO) materials have been disclosed as solar control window coverings. For example, Nishihara, et. al., in U.S. Pat. No. 5,518,810, disclose the use of ATO and ITO particles in infrared ray cutoff coatings. Takizawa, et. al., in U.S. Pat. No. 6,191,884, U.S. Pat. No. 6,261,684 and U.S. Pat. No. 6,528,156, disclose coatings which include ITO particles onto a film substrate for use as solar control window films. These films are disclosed to be stuck to the windows with a thin layer of contact adhesive.

Infrared-absorbing metal boride nanoparticles which have attained commercial significance include lanthanum hexaboride (LaB6). Adachi, et. al., in U.S. Pat. No. 6,060,154, disclose solar control films which include LaB6 nanoparticles. Kuno, et. al., in U.S. Pat. No. 6,221,945, U.S. Pat. No. 6,277,187, disclose films produced by coating LaB6 onto a substrate film for use in solar control. Takeda, et. al., in U.S. Pat. No. 6,319,613 and EP 1 008 564, disclose solar control films which include LaB6 nanoparticles in combination with ATO or ITO. These films are disclosed to be window covering films. Barth, et. al., in U.S. Pat. No. 6,663,950, disclose solar control window films comprising a transparent polymeric film substrate, such as a poly(ethylene terephthalate) film, having a UV-absorbing material coated with a hardcoat layer having a thickness of less than 6 microns.

One development to produce solar control laminated glass which reflects infrared energy includes the inclusion of metallized substrate films, such as polyester films, which have electrically conductive metal layers, such as aluminum or silver metal, typically applied through a vacuum deposition or a sputtering process. These supported metal stacks are disclosed within glass laminates in, for example, U.S. Pat. No. 3,718,535, U.S. Pat. No. 3,816,201, U.S. Pat. No. 3,962,488, U.S. Pat. No. 4,017,661, U.S. Pat. No. 4,166,876, U.S. Pat. No. 4,226,910, U.S. Pat. No. 4,234,654, U.S. Pat. No. 4,368,945, U.S. Pat. No. 4,386,130, U.S. Pat. No. 4,450,201, U.S. Pat. No. 4,465,736, U.S. Pat. No. 4,782,216, U.S. Pat. No. 4,786,783, U.S. Pat. No. 4,799,745, U.S. Pat. No. 4,973,511, U.S. Pat. No. 4,976,503, U.S. Pat. No. 5,024,895, U.S. Pat. No. 5,069,734, U.S. Pat. No. 5,071,206, U.S. Pat. No. 5,073,450, U.S. Pat. No. 5,091,258, U.S. Pat. No. 5,189,551, U.S. Pat. No. 5,264,286, U.S. Pat. No. 5,306,547, U.S. Pat. No. 5,932,329, U.S. Pat. No. 6,391,400, and U.S. Pat. No. 6,455,141. The metallized films are generally disclosed to reflect the appropriate light wavelengths to provide the solar control properties desired. For example, Fujimori, et. al., in U.S. Pat. No. 4,368,945, disclose an infrared reflecting laminated glass for automobile consisting of an infrared reflecting film sandwiched between polyvinylbutyral layers which incorporate ultraviolet absorbents. Brill, et. al., in U.S. Pat. No. 4,450,201, disclose a multilayer heat barrier film. Nishihara, et. al., in U.S. Pat. No. 4,465,736, disclose a laminate with a selective light transmitting film. Woodard, in U.S. Pat. No. 4,782,216 and U.S. Pat. No. 4,786,783, discloses a transparent, laminated window with near IR rejection which included two transparent conductive metal layers.

Farmer, et. al., in U.S. Pat. No. 4,973,511, disclose a laminated solar window construction which includes a PET sheet with a multilayer solar coating. Woodard, in U.S. Pat. No. 4,976,503, discloses an optical element for a motor vehicle windshield which includes light-reflecting metal layers. Hood, et. al., in U.S. Pat. No. 5,071,206, disclose reflecting interference films. Moran, in U.S. Pat. No. 5,091,258, discloses a laminate which incorporates an infra-red radiation reflecting interlayer. Frost, et. al., in U.S. Pat. No. 5,932,329, disclose a laminated glass pane comprising a transparent support film of a tear-resistant polymer provided with an IR-reflecting coating and two adhesive layer. Woodard, et. al., in U.S. Pat. No. 6,204,480, disclose thin film conductive sheets for automobile windows. Russell, et. al., in U.S. Pat. No. 6,391,400, disclose dielectric layer interference effect thermal control glazings for windows. Woodard, et. al., in U.S. Pat. No. 6,455,141, disclose a laminated glass that incorporates an interlayer carrying an energy-reflective coating. Longmeadow, in EP 1 342 565, discloses embossed reflective laminates.

A more recent societal need is for image-bearing (e.g., decorated) glass laminates which include an image or decoration. Automotive windshield tint bands, used to help shield the driver's eyes from the sun's glare, may be considered as a form of decorative laminates. These are generally dyed or printed directly onto the automotive windshield interlayer. For example, automotive windshield tint bands are disclosed in; U.S. Pat. No. 3,008,858, U.S. Pat. No. 3,346,526, U.S. Pat. No. 3,441,361, U.S. Pat. No. 3,450,552, U.S. Pat. No. 3,973,058, U.S. Pat. No. 4,303,718, U.S. Pat. No. 4,341,683 and JP 2053298.

Image-bearing glass laminates derived from printed interlayers are known within the art. For example, Cesar, in U.S. Pat. No. 4,968,553, discloses an image-bearing polyurethane interlayer for use in glass laminates. Image-bearing poly(vinyl butyral) sheets for glass laminates have been produced through transfer printing processes. See, for example, U.S. Pat. No. 4,173,672, U.S. Pat. No. 4,976,805, U.S. Pat. No. 5,364,479, U.S. Pat. No. 5,487,939, U.S. Pat. No. 6,235,140, WO 95/06564 and WO 2004/039607. Sol, et. al., in U.S. Pat. No. 5,914,178, disclose glass laminates which include silk screen image-bearing poly(vinyl butyal) interlayers. Reynolds, et. al., in US 2004/0234735 and WO 02/18154, disclose a method of producing image carrying laminated materials. Elwakil, et. al., in WO 2004/018197, disclose a process for obtaining an image-bearing laminate having a laminate adhesive strength of at least 1000 psi, which includes ink jet printing a digital image onto a thermoplastic interlayer selected from polyvinyl butyrals, polyurethanes, polyethylenes, polypropylenes, polyesters, and EVA using certain pigmented inks. Roman, et. al., in U.S. Pat. No. 7,041,163, disclose an inkjet ink set comprising a plurality of non-aqueous, colored, pigmented inks suitable for ink jet printing Surlyn® (E. I. du Pont de Nemours and Company, Wilmington, Del. (DuPont)). Smith, et. al., in WO 2004/011271, disclose a process for ink-jet printing an image onto an ethylene/(meth)acrylic acid ionomer rigid thermoplastic interlayer sheet with a finite thickness of less than or equal to about 0.38 mm. Directly printing onto interlayers generally has the shortcomings of complicated processes, low image definition due to printing onto soft sheets and dimensional instability of the image-bearing interlayer; to interactions between the decoration and the sheet composition, such as plasticizers; and low interlayer adhesion, which significantly reduces their utility as safety glass. For example, US 2003/0203167 and WO 03/092999 generally teach against decorative poly(vinyl butyral) interlayers and exemplifies that glass laminates produced therefrom would not have the integrity to be used in many applications due to low glass-to-interlayer adhesion.

Image-bearing glass is known within the art. For example, U.S. Pat. No. 4,024,096, U.S. Pat. No. 5,596,027, U.S. Pat. No. 5,652,286, U.S. Pat. No. 5,693,127, U.S. Pat. No. 5,744,519, U.S. Pat. No. 6,221,933, U.S. Pat. No. 6,444,019, and WO 03/006394 disclose ink sets suitable for the decoration of glass substrates through ink jet processes. Further decorated glass disclosures include, for example; U.S. Pat. No. 5,370,913, U.S. Pat. No. 5,766,702, and U.S. Pat. No. 6,336,723. US 2006/0191625 discloses a glass decorated with a crosslinkable thermoset resin with pigments, and glass laminates produced therefrom with poly(vinyl butyral) interlayers.

Decorative window films are disclosed within the art in, for example, U.S. Pat. No. 5,049,433, U.S. Pat. No. 5,468,532, U.S. Pat. No. 5,505,801, and WO 83/03800. As is well known within the art, window films are subject to environmental stresses within the normal usage and tend to delaminate over time.

Decorative (image-bearing) glass laminates have been produced through the incorporation of image-bearing films in, for example, US 2003/0203167, US 2002/0119306, EP 0 160 510, EP 1 129 844, DE 29706880, DE 20100717, and WO 03/092999. For example, Bell, et. al., in U.S. Pat. No. 6,824,868, disclose a film with a color image-bearing film with a 2 mil thick adhesive film covering the image and a second non-image-bearing film on the opposite surface of the adhesive film. This complicated construct is to protect the image from degradation from, for example, poly(vinyl butyral) plasticizers, and due to low adhesion at the image interface. They teach against the direct inclusion of image-bearing films into laminates and teach against the use of ink jet printing processes in forming the image. Such embedded film image-bearing laminates suffer from inefficient, complicated processes, low image sharpness and stability and/or low interlayer adhesion, which significantly degrade their utility as safety glass.

As disclosed above, shortcomings of the art include the lack of interlayer adhesion, especially at the image-bearing interface, which significantly reduces the attributes commonly assumed for safety glass, such are commonly incorporated within poly(vinyl butyral) interlayers, providing reduced image sharpness and undesirably complicated processes to produce the image-bearing article and the glass laminate therefrom. The invention overcomes these shortcomings and provides image-bearing (e.g., decorated) safety glass laminates with high interlayer adhesion, image stability and preferably solar control attributes which maintain the safety aspects generally assumed for laminated safety glass.

### SUMMARY OF THE INVENTION

The invention is directed to an image-bearing article comprising a film layer bearing an image which is coated on the image-bearing side and over the image with an adhesion promoter and which is adhered by the adhesion promoter to an ionomeric interlayer, wherein the ionomeric interlayer comprises an ionomeric copolymer of an alpha-olefin and about 15 to about 30 wt % of an alpha, beta-ethylenically unsaturated carboxylic acid having 3 to 8 carbons, based on the total weight of the ionomeric copolymer and wherein about 5% to about 90% of the carboxylic acids in the ionomeric copolymer are neutralized with one or more metal ions

Preferably the article further comprises a rigid sheet adhered to the ionomeric interlayer. In a preferred embodiment, the rigid sheet is a sheet of glass.

Preferably the adhesion promoter is selected from the group consisting of silanes and poly(alkyl amine) adhesion promoters, and mixtures thereof. In one preferred embodiment, the adhesion promoter is an aminosilane. In another preferred embodiment, the adhesion promoter is selected from the group consisting of poly(vinyl amine), poly(allyl amine) and mixtures thereof. Preferred adhesion promoters include vinyltriethoxysilane, vinyltrimethoxysilane, vinyltris(beta-methoxyethoxy)silane, gamma-methacryloxypropyltrimethoxysilane, beta-(3,4-epoxycyclohexyl)ethyltrimethoxysilane, gamma-glycidoxypropyltrimethoxysilane, gamma-glycidoxypropylmethyldiethoxysilane, vinyl-triacetoxysilane, gamma-mercaptopropyltrimethoxysilane, (3-aminopropyl)trimethoxysilane, (3-aminopropyl)triethoxysilane, N-beta-(aminoethyl)-gamma-aminopropyl-trimethoxysilane, N-(beta-aminoethyl)gamma-aminopropylmethyldimethoxysilane, aminoethylaminopropyl silane triol homopolymer, vinylbenzylaminoethylaminopropyltrimethoxysilane, bis(trimethoxysilylpropyl)amine, and mixtures thereof. Most preferred are gamma-aminopropyltriethoxysilane, and N-beta-(aminoethyl)-gamma-aminopropyl-trimethoxysilane and mixtures thereof.

In a preferred embodiment, the film layer is a polyester film, preferably a biaxially-oriented, poly(ethylene terephthalate) film.

In a preferred embodiment, the film layer is a solar control film.

In a preferred embodiment, the adhesion coating has a thickness of less than 1 mil.

In a preferred embodiment, the image comprises UV-curable ink.

In a preferred embodiment, the image comprises pigment ink.

In a preferred embodiment, the pigment ink comprises pigments selected from the group consisting of Color Index PY120, PY155, PY128, PY180, PY95, PY93, PV19/PR202, PB15:3, PB15:4, PR122, PB17, and mixtures thereof.

In a preferred embodiment, the image comprises a black ink.

In a preferred embodiment, the image comprises a white ink.

In a preferred embodiment, the image is formed from solvent-based ink.

Preferably the image-bearing article has a laminate adhesive strength of about 1000 psi or greater.

In a preferred embodiment, the adhesion coating has a thickness of up to about 1 mil, the ionomeric interlayer has a thickness of about 10 to about 250 mils, and the film layer has a thickness of about 0.1 mils to about 10 mils.

In one preferred embodiment, the invention is directed to an image-bearing article comprising: (a) a first rigid sheet selected from the group consisting of glass, poly(carbonate), and poly(methacrylate) sheets and laminated to, (b) a first ionomeric interlayer sheet comprising a first ionomeric copolymer of an alpha-olefin and about 15 to about 30 wt % of an alpha, beta-ethylenically unsaturated carboxylic acid having 3 to 8 carbons, based on the total weight of the first ionomeric copolymer, and wherein about 5% to about 90% of the carboxylic acids in the first ionomeric copolymer are neutralized with one or more metal ions, which is laminated to, (c) a film layer having one side bearing an image, wherein an adhesion promoter selected from the group consisting of aminosilane, poly(vinyl amine), poly(allyl amine) and mixtures thereof is coated over the image and directly adhered to the first ionomeric interlayer, and wherein the non-image-bearing side of the film layer is laminated to, (d) a second ionomeric interlayer sheet comprising a second ionomeric copolymer of an alpha-olefin and about 15 to about 30 wt % of an alpha, beta-ethylenically unsaturated carboxylic acid having 3 to 8 carbons, based on the total weight of the second ionomeric copolymer, and wherein the about 5% to about 90% of the carboxylic acids in the second ionomeric copolymer are neutralized with one or more metal ions, which is laminated to, (e) a second rigid sheet selected from the group consisting of glass, poly(carbonate), and poly(methacrylate) sheets.

In one preferred embodiment, the first and second rigid sheets are glass sheets and the film layer is a solar control film.

The invention is also directed to a process of preparing an image-bearing article comprising a coated image-bearing film layer, which comprises the steps of: (a) providing a film layer; (b) printing an image on the film layer so as to produce an image-bearing film layer containing an image-bearing side; (c) coating an adhesion promoter on the image-bearing side and over the image to produce the coated image-bearing film layer; and (d) laminating an ionomeric interlayer sheet to the image-bearing side of the coated image-bearing film layer, wherein the ionomeric interlayer sheet comprises a ionomeric copolymer of an alpha-olefin and about 15 to about 30 wt % of an alpha, beta-ethylenically unsaturated carboxylic acid having 3 to 8 carbons, based on the total weight of the copolymer, and wherein about 5% to about 90% of the carboxylic acids in the ionomeric copolymer are neutralized with one or more metal ions.

The process preferably further comprises laminating a rigid sheet to the ionomeric interlayer sheet. In a preferred embodiment, the film layer is a solar control film. Preferably the printing comprises ink jet printing. Preferably the lamination step includes applying heat and, optionally, pressure.

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Although methods and materials similar or equivalent to those described herein can be used in the practice or testing of the invention, suitable methods and materials are described herein.

Unless stated otherwise, all percentages, parts, ratios, etc., are by weight. When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.”

Where applicants have defined an invention or a portion thereof with an open-ended term such as “comprising,” it should be readily understood that (unless otherwise stated) the description should be interpreted to also describe such an invention using the terms “consisting essentially of” or “consisting of.” Use of “a” or “an” are employed to describe elements and components of the invention. This is done merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

The invention is based upon the discovery that it is possible to prepare image-bearing glass laminates from certain ionomeric interlayers and certain adhesive primed, image-bearing film layers produced through an ink jet printing process with superior image sharpness and interlayer adhesion, desirably maintaining the safety aspects commonly associated with safety glass.

In one embodiment, the image-bearing film, which is suitable for use in safety glass laminar structures, has an image applied to its image-bearing side through an ink jet printing process and an adhesion promoter coated over the image.

### Film Layer

The film layer is preferably selected from the group consisting of polymeric film and solar control film. The polymeric film can comprise any polymer known. Specific examples of preferable film materials include; (meth)acrylic compositions, (meth)acrylate ester compositions, polystyrene materials, polyolefin materials, polyethylene compositions, polypropylene compositions, urethane compositions, epoxy compositions, polyester compositions, alkyd resins, polyamide materials, phenoxy compositions, melamine compositions, chlorine-containing materials, fluorine-containing materials, poly(vinyl acetals), polyether compositions, silicone compositions, ABS materials, polysulfone compositions, poly(vinyl chloride) materials, poly(vinylidene chloride) materials, poly(vinyl acetate) materials, poly(vinyl alcohol) materials, poly(phenylene oxide) materials, cellulose derivatives, poly-4-methylpentene, polytetrafluoroethylene, polytrifluoroethylene, polyvinylidene fluoride, ultralow density polyethylene, poly(ethylene-co-vinyl acetate) resins, poly(ethylene-co-glycidylmethacrylate), poly(ethylene-co-(meth)acrylic acid), metal salts of poly(ethylene-co-(meth)acrylic acid), poly(ethylene-co-carbon monoxide), poly(cyclic olefins), poly(ethylene terephthalate), poly(1,3-propyl terephthalate), poly(1,4-butylene terephthalate), poly(ethylene-co-1,4-cyclohexanedimethanol terephthalate), poly(ethylene-co-2,6-naphthalate), syndiotactic polystyrene, polycarbonates, poly(bisphenol A carbonate), starch derivatives, modified starch, cellulose, cellulose derivatives and the like and copolymers thereof and mixtures thereof. This should not be considered limiting. Essentially any polymer may find utility as the polymeric film material of the invention.

Preferably, the polymeric film is transparent. More preferable polymeric film materials include; poly(ethylene terephthalate), poly(1,3-propyl terephthalate), poly(1,4-butylene terephthalate), poly(ethylene-co-1,4-cyclohexanedimethanol terephthalate), polycarbonate, polypropylene, polyethylene, polypropylene, cyclic polyolefins, norbornene polymers, polystyrene, syndiotactic polystyrene, polysulfone, polyamides, poly(urethanes), acrylics, cellulose acetates, cellulose triacetates, cellophane, poly(vinyl chloride) polymers, poly(vinyl fluoride), poly(vinylidene fluoride) and the like. Most preferably, the polymeric film is a biaxially-oriented poly(ethylene terephthalate) film.

Preferably, one or both surfaces of the polymeric film may be treated to enhance the adhesion to the image, to the interlayer, to other laminate layers or a combination thereof. This treatment may take any form known within the art, including adhesives, primers, such as silanes, flame treatments, such as disclosed within U.S. Pat. No. 2,632,921, U.S. Pat. No. 2,648,097, U.S. Pat. No. 2,683,894, and U.S. Pat. No. 2,704,382, plasma treatments, such as disclosed within U.S. Pat. No. 4,732,814, electron beam treatments, oxidation treatments, corona discharge treatments, chemical treatments, chromic acid treatments, hot air treatments, ozone treatments, ultraviolet light treatments, sand blast treatments, solvent treatments, and the like and combinations thereof. For example, a thin layer of carbon may be deposited on one or both surfaces of the polymeric film through vacuum sputtering as disclosed in U.S. Pat. No. 4,865,711. For example, U.S. Pat. No. 5,415,942 discloses a hydroxy-acrylic hydrosol primer coating that may serve as an adhesion-promoting primer for poly(ethylene terephthalate) films.

Preferably, the polymeric film of the invention includes a primer coating on one or both surfaces, more preferably both surfaces, comprising a coating of a polyallylamine-based primer. The polyallylamine-based primer and its application to a poly(ethylene terephthalate) polymeric film are disclosed within U.S. Pat. No. 5,411,845, U.S. Pat. No. 5,770,312, U.S. Pat. No. 5,690,994, U.S. Pat. No. 5,698,329 and U.S. Pat. No. 7,189,457. Generally, the poly(ethylene terephthalate) film is extruded and cast as a film by conventional methods, as described above, and the polyallylamine coating is applied to the poly(ethylene terephthalate) film either before stretching or between the machine direction stretching and transverse direction stretching operations, and/or after the two stretching operations and heat setting in the stenter oven. It is preferable that the coating be applied before the transverse stretching operation so that the coated poly(ethylene terephthalate) web is heated under restraint to a temperature of about 200 to about 240° C., preferably about 220° C. in the stenter oven in order to cure the polyallylamine to the poly(ethylene terephthalate) surface(s). In addition to this cured coating, an additional polyallylamine coating can be applied on it after the stretching and stenter oven heat setting in order to obtain a thicker overall coating.

The thickness of the polymeric film is not critical and may be varied depending on the particular application. Generally, the thickness of the polymeric film will range from about 0.1 mils (0.003 mm) to about 10 mils (0.26 mm). For automobile windshields, the polymeric film thickness may be preferably within the range of about 1 mil (0.025 mm) to about 4 mils (0.1 mm). The polymeric film is preferably sufficiently stress-relieved and shrink-stable under the coating and lamination processes. Preferably, the polymeric film is heat stabilized to provide low shrinkage characteristics when subjected to elevated temperatures (i.e. less than 2 percent shrinkage in both directions after 30 minutes at 150° C.), such are seen through the lamination processes described below.

Preferably, the film layer is a solar control film. The solar control film may reflect infrared light, absorb infrared light or a combination thereof. Polymeric films coated with indium tin oxide (ITO) nanoparticles incorporated within a matrix material are commercially available. For example, the Tomoegawa Paper Company, Ltd. (Tokyo, Japan) offers a line of solar control films within their Soft Look® film product offering. These solar control films are disclosed as window coverings which are affixed to the outside of a window. The Soft Look® solar control films are described as ITO nanoparticles dispersed within a matrix material and solution coated on biaxially-stretched poly(ethylene terephthalate) film. The Soft Look® solar control films also incorporate a UV shielding hard coat layer on top of the ITO infrared shielding layer and may further incorporate adhesive layers as the outer layers of the films. Typical reported optical properties of the Soft Look® solar control films are, for example; a visible radiation transmittance of 85.80 percent, sunlight radiation transmittance of 68.5 percent, a sunlight reflectance of 7.9 percent, and a screening factor of 0.86. The Soft Look® solar control films are also typically hardcoated to improve the abrasion resistance. Specific grades of Soft Look® solar control films include; Soft Look® UV/IR 25 solar control film and Soft Look® UV/IR 50 solar control film.

Polymeric films coated with antimony tin oxide (ATO) nanoparticles incorporated within a matrix material are also commercially available. For example, the Sumitomo Osaka Cement Company (Tokyo, Japan) offers a line of solar control films within their RAYBARRIER® film product offering. These solar control films are disclosed as window coverings which are affixed to the outside of a window. The RAYBARRIER® solar control films are described as ATO nanoparticles with a nominal particle size of about 10 nm dispersed within a matrix material and coated on biaxially-stretched poly(ethylene terephthalate) film. Typical reported optical properties of the RAYBARRIER® solar control films are, for example; a visible radiation transmittance of 78.9 percent, sunlight radiation transmittance of 66.0 percent, a sunlight reflectance of 8.4 percent, a UV transmittance of 0.4 percent, and a screening factor of 0.8. The RAYBARRIER® solar control films are also typically hardcoated to improve the abrasion resistance, with typical values of a delta H (defined as the haze difference of before and after the Taber abrasion test), of 4.9 percent within a Taber abrasion test (abrasion wheel: CS-10F, Load: 1000 grams and abrasion cycle: 100 cycles), a pass through a steelwool scratching test (steelwool: #0000, load: 200 grams, abrasion times: 200 times back-and-fort, a pass is defined as “not scratched”), and a Pencil Hardness of 2H (Load: 1000 grams). Specific grades of RAYBARRIER® solar control films include; RAYBARRIER® TFK-2583 solar control film with a visible radiation transmittance of 81.6 percent, a sunlight radiation transmittance of 66.8 percent and a haze value of 1.1 percent, RAYBARRIER® TFM-5065 solar control film with a visible radiation transmittance of 67.1 percent, a sunlight radiation transmittance of 47.5 percent and a haze value of 0.4 percent, RAYBARRIER® SFJ-5030 solar control film with a visible radiation transmittance of 29.2 percent, a sunlight radiation transmittance of 43.0 percent and a haze value of 1.0 percent, RAYBARRIER® SFI-5010 solar control film with a visible radiation transmittance of 12.0 percent, a sunlight radiation transmittance of 26.3 percent and a haze value of 0.8 percent, RAYBARRIER® SFH-5040 solar control film with a visible radiation transmittance of 41.5 percent, a sunlight radiation transmittance of 41.9 percent and a haze value of 0.7 percent and RAYBARRIER® SFG-5015 solar control film with a visible radiation transmittance of 14.8 percent, a sunlight radiation transmittance of 20.9 percent and a haze value of 0 percent.

Polymeric films which incorporate lanthanum hexaboride (LaB6) nanoparticles are commercially available. For example, the Sumitomo Metal Mining Company (Tokyo, Japan) offers a line of solar control films which incorporate LaB6 nanoparticles. These solar control films are disclosed as window coverings which are affixed to the outside of a window.

The solar control films can incorporate other absorptive materials, such as, for example, organic infrared absorbents, for example, polymethine dyes, amminium dyes, imminium dyes, dithiolene-type dyes and phthalocyanine-type dyes and pigments, and the like and combinations thereof.

More preferably, the solar control film reflects the infrared light. One example of the preferable solar control film that reflects infrared light is disclosed in U.S. Pat. No. 6,368,699, WO 99/36808 and WO 99/36810. A further example is the preferable metallized polymeric film infrared reflector which may include any film with an infrared energy reflective layer. The layer may range from a simple semi-transparent metal layer or be a series of metal/dielectric layers. Such stacks are commonly referred to as interference filters of the Fabry-Perot type. Each layer may be angstrom-thick or thicker. The thickness of the various layers in the filter are controlled to achieve an optimum balance between the desired infrared reflectance while maintaining the also desired visible light transmittance. The metal layer(s) are separated (i.e. vertically in the thickness direction) from each other by one or more dielectric layers so reflection of visible light from the metal layer(s) interferes destructively thereby enhancing visible light transmission.

Suitable metals for the metal layer(s) include, for example, silver, palladium, aluminum, chromium, nickel, copper, gold, zinc, tin, brass, stainless steel, titanium nitride, and alloys or claddings thereof. For optical purposes, silver and silver-gold alloys are preferred. Metal layer thickness are generally in the range of from about 60 to about 200 Angstrom, preferably within the range from about 80 to about 140 Angstrom. In general, the dielectric material should be chosen with a refractive index which is greater than the material outside the coating it abuts. In general, a higher refractive index of the dielectric layer(s) is desirable. Preferably, the dielectric material will have a refractive index of greater than about 1.8. More preferably, the dielectric material will have a refractive index of greater than about 2.0. The dielectric layer material should be transparent over the visible range and at least one dielectric layer must exist between a pair of metal layers. Suitable dielectric materials for the dielectric layer(s) include, for example; zirconium oxide, tantalum oxide, tungsten oxide, indium oxide, tin oxide, indium tin oxide, aluminum oxide, zinc sulfide, zinc oxide, magnesium fluoride, niobium oxide, silicon nitride, and titanium oxide. Preferably dielectric materials include tungsten oxide, indium oxide, tin oxide, and indium tin oxide. Generally, the layers are formed through vacuum deposition processes, such as vacuum evaporation processes or sputtering deposition processes.

Examples of such processes include resistance heated, laser heated or electron-beam vaporization evaporation processes and DC or RF sputtering processes (diode and magnetron) under normal and reactive conditions. Preferably, the layer is made up of one or more semi transparent metal layers bounded on each side by transparent dielectric layers. One form known as an interference filter comprises at least one layer of reflective metal sandwiched between reflection-suppressing or anti-reflective dielectric layers. These layers are usually arranged in sequence as stacks carried by an appropriate transparent planar substrate such as a biaxially-oriented poly(ethylene terephthalate) film or equivalent film. These layers can be adjusted to reflect particular wave lengths of energy, in particular heat and other infrared wavelengths, as disclosed in, for example; U.S. Pat. No. 4,799,745, U.S. Pat. No. 4,973,511, and the references disclosed above. As is generally known within the art, varying the thickness and composition of a dielectric layer spaced between two reflecting metal layers will vary the optical transmittance/reflection properties considerably. More specifically, varying the thickness of the spacing dielectric layer varies the wave length associated with the reflection suppression (or transmission enhancement) band. In addition to the choice of metal, thickness also determines its reflectivity. Generally, the thinner the layer, the less is its reflectivity. Generally, the thickness of the spacing dielectric layer(s) is between about 200 to about 1200 Angstrom, preferably between about 450 to about 1000 Angstrom, to obtain the desired optical properties. The preferred dielectric stack for the automotive end-uses contains at least two near infrared reflecting metal layers which in operative position transmit at least 70 percent visible light of normal incidence measured as specified in ANSI Z26.1. Architectural applications may utilize dielectric stacks with lower levels of visible light transmittance. Preferably, visible light reflectance, normal from the surface of the stack is less than about 8 percent. Exterior dielectric layers in contact with the metal layer surfaces opposite to the metal surfaces contacting spacing dielectric layer(s) further enhance anti-reflection performance. The thickness of such exterior or outside dielectric layer(s) is generally about 20 to about 600 Angstrom, preferably about 50 to about 500 Angstrom. This should not be considered limiting. Essentially any metallized polymeric film infrared reflector will find utility within the invention.

Commercial examples of such metal dielectric constructs are manufactured by Southwall Technologies, Inc. (Palo Alto, Calif.) in laminated and non-laminated structures with silver and silver/gold as the metal and indium oxide and indium tin oxide as the dielectric. Specific examples of commercially-available metal dielectric constructs from Southwall Technologies, Inc., include, for example, XIR® 70, which is reported to have a 70 percent visible light transmittance, a 9 percent visible light reflectance, (exterior), a 46 percent total solar transmittance, a 22 percent solar reflectance, (exterior), a relative heat gain of 117 and a greater than 99 percent ultraviolet blockage and XIR® 75, which is reported to have a 75 percent visible light transmittance, a 11 percent visible light reflectance, (exterior), a 52 percent total solar transmittance, a 23 percent solar reflectance, (exterior), a relative heat gain of 135 and a greater than 99 percent ultraviolet blockage, when placed in a 2.1 mm clear glass/XIR® film/polyvinyl butyral interlayer/2.1 mm clear glass construction.

### Imaging Process

The image (e.g., decoration) may be applied to the film layer by any known art method. Such methods may include, for example; air-knife, printing, painting, Dahlgren, gravure, spraying, thermal transfer print printing, silk screen, thermal transfer, inkjet printing or other art processes. Preferably, the image is applied to the film layer through digital ink jet printing processes. The image can include, for example, an image, symbol, geometric pattern, photograph, alphanumeric character, and the like and combinations thereof. Such ink jet processes provide the speed and flexibility to meet the needs for producing limited quantities of customized image-bearing layers and laminates at a reasonable cost, which are not available through other, more complex printing processes, such as thermal transfer printing. Inkjet is the dominant print technology in many markets, including desktop publishing and digital photography and is continuing to expand into other areas, such as textile and fabric printing. A major advantage of digital ink jet printing is the minimal setup times required to produce an image which reduces both the cost and turnaround time for a short, customized image production, especially when compared to traditional screen printing operations.

Inkjet printing is typically a wet-imaging, non-contact process where a vehicle or carrier fluid is energized to “jet” ink components from a printhead over a small distance onto a substrate. The vehicle may be solvent based, aqueous based, or a combination thereof and may contain dyes, pigments or a combination thereof. Along with the colorant, an inkjet ink formulation may contain humectants, surfactants, biocides, and penetrants along with other ingredients. Inkjet technologies include continuous and drop-on-demand types, with the drop-on-demand printing the most common. Inkjet printheads generally fall within two broad categories; thermal printheads, mainly used with aqueous inks and piezo-electric printheads, mainly used with solvent inks. Inkjet printer resolutions can now exceed 1440 dpi with photographic and continuous capabilities. Preferably, the image is printed onto the image-bearing layer using a piezo-electric drop-on-demand digital printing process.

A wide array of color options are commercially available for ink jet printing including the standard cyan, magenta, yellow and black (C-M-Y-K) process colors as well as spot color options such as white, metallics, fluorescents, and specialized colors. The term “color” includes all colors including black and white. The colorants are preferably pigments because of their well-known advantage in fade resistance when exposed to sunlight (color fastness) when compared to dyes. Pigments are further preferred because of their thermal stability, edge definition, and low diffusivity on the printed substrate. In conventional practice, the pigment is suspended in a liquid medium that is conventionally referred to as the “vehicle”. Pigments suitable for use in the practice can be dispersed in an aqueous or a non-aqueous vehicle. The ink can comprise colorant that is dispersed (pigment) in the ink vehicle. The ink vehicle can be aqueous, non-aqueous and the ink is referred to as aqueous or non-aqueous ink, accordingly. Aqueous ink is advantageous because water is especially environmentally friendly.

Preferably, the process uses a solvent based ink system. The term “solvent based ink system” refers to a system in which a colorant is carried in a suitable organic solvent or mixture of solvents, for example, a pigment is dispersed in an organic solvent or mixture of solvents. Such inks include the so called “oil based” inks.

Dispersion of pigment in non-aqueous vehicle is substantially different than dispersion in aqueous vehicle. Generally, pigments that can be dispersed well in water do not disperse well in non-aqueous solvent, and vice versa. Also, the demands of ink-jet printing are quite rigorous and the standards of dispersion quality are high. While pigments may be “well dispersed” for other applications, they may still be inadequately dispersed for inkjet applications.

Preferably, the ink set comprises at least three different, non-aqueous, colored pigmented inks (CMY), at least one of which is a magenta ink, at least one of which is a cyan ink, and at least one of which is a yellow ink dispersed in a non-aqueous vehicle.

More preferably, the yellow pigment preferably is chosen from the group consisting of Color Index PY120, PY155, PY128, PY180, PY95, PY93 and mixtures thereof. Even more preferably, the yellow pigment is Color Index PY120. A commercial example is PV Fast Yellow H2G (Clariant Corporation, Charlotte, N.C.). This pigment has the advantageous color properties of favorable hue angle, good chroma, and light fastness and further disperses well in non-aqueous vehicle. Even more preferably, the magenta ink comprises a complex of PV19 and PR202 (also referred to as PV19/PR202) dispersed in a non-aqueous vehicle. A commercial example is Cinquasia Magenta RT-255-D (Ciba Specialty Chemicals Corporation, Tarrytown, N.Y.). As noted above, the pigment particles can be an intimate complex of the PV19 and PR202 species and not simply a physical mixture of the individual PV19 and PR202 crystals. This pigment has the advantageous color properties of quinacridone pigments such as PR122 with favorable hue angle, good chroma, and light fastness and further disperses well in non-aqueous vehicle. In contrast, PR122 pigment does not disperse well under similar conditions. Also preferred is a cyan ink comprising PB 15:3 and/or PB 15:4 dispersed in a non-aqueous vehicle. Other preferable pigments include, for example, PR122 and PB17. The above noted pigment designations are color index numbers.

Preferably, the ink set further comprises a non-aqueous, pigmented black ink, preferably comprising a carbon black pigment dispersed in a non-aqueous vehicle. More preferably, the ink set comprises at least four inks (CMYK). The ink set may comprise a greater number of inks, with 6 inks and 8 inks being common.

This ink set is advantageous because of the desirable combination of plasticizer resistance, chroma, transparency, light fastness and dispersion quality.

The percent coverage of the image is determined by the number of inks utilized within a particular ink set and is defined as it is defined within the art. This includes the option for multistrikes on the same area. Generally this provides for up to 100% coverage on the film layer for each ink used within a certain ink set. For example, if the ink set includes three inks, then up to 300% coverage is possible. As a further example, if the ink set includes four inks, then up to 400% coverage is possible.

As described above, the preferably colorant in the inks of the ink set is a pigment. By definition, pigments do not form (to a significant degree) a solution in the vehicle and must be dispersed. Traditionally, pigments are stabilized to dispersion by dispersing agents, such as polymeric dispersants or surfactants.

More recently, so-called “self-dispersible” or “self-dispersing” pigments (“SDP(s)”) have been developed. As the name would imply, SDPs are dispersible in a vehicle without added dispersants.

Further pigments for inkjet applications are generally well known. A representative selection of such pigments are found, for example, in U.S. Pat. No. 5,026,427, U.S. Pat. No. 5,086,698, U.S. Pat. No. 5,141,556, U.S. Pat. No. 5,169,436 and U.S. Pat. No. 6,160,370, the disclosures of which are incorporated by reference herein for all purposes as if fully set forth. The exact choice of pigment will depend upon color reproduction and print quality requirements of the application.

Dispersants to stabilize the pigments to dispersion are preferably polymeric because of their efficiency. The dispersant can be a random or structured polymeric dispersant. Preferred random polymers include acrylic polymers and styrene-acrylic polymers. More preferable, the dispersant is a structured dispersant such as, for example, AB, BAB and ABC block copolymers, branched polymers and graft polymers. Useful structured polymers are disclosed in, for example, U.S. Pat. No. 5,085,698, EP A 0556649 and U.S. Pat. No. 5,231,131.

Suitable pigments also include SDPs. SDPs for aqueous inks are well known. SDPs for non-aqueous inks are also known and include, for example, those described in U.S. Pat. No. 5,698,016, US 2001003263, US 2001004871, US 20020056403 and WO 01/94476, the disclosures of which are incorporated by reference herein for all purposes as if fully set forth. The techniques described therein could be applied to the pigments of the invention.

It is desirable to use small pigment particles for maximum color strength and good jetting. The particle size may generally be in the range of from about 0.005 micron to about 15 microns, is typically in the range of from about 0.005 to about 1 micron, is preferably from about 0.005 to about 0.5 micron, and is more preferably in the range of about 0.01 to about 0.3 micron.

The levels of pigment employed in the inks are those levels that are typically needed to impart the desired optical density to the printed image. Typically, pigment levels are in the range of from about 0.01 to about 10 wt %, based on the total weight of the ink.

“Non-aqueous vehicle” refers to a vehicle that is substantially comprised of a non-aqueous solvent or mixtures of such solvent, which solvents can be polar and/or nonpolar. Examples of polar solvents include, for example, alcohols, esters, ketones and ethers, particularly mono- and di-alkyl ethers of glycols and polyglycols such as monomethyl ethers of mono-, di- and tri-propylene glycols and the mono-n-butyl ethers of ethylene, diethylene, and triethylene glycols. Useful, but less preferred, polar solvents include, for example, methyl isobutyl ketone (MIBK), methyl ethyl ketone (MEK), butyrolactone, and cyclohexanone. Examples of nonpolar solvents include, for example, aliphatic and aromatic hydrocarbons having at least six carbon atoms and mixtures thereof including refinery distillation products and byproducts.

Even when no water is deliberately added to the non-aqueous vehicle, some adventitious water may be carried into the formulation, but generally this will be no more than about 2 to about 4%. By definition, the non-aqueous ink will have no more than about 10 wt %, and preferably no more than about 5 wt %, of water based on the total weight of the non-aqueous vehicle. In a preferred embodiment, dipropylene glycol monomethyl ether acetate (DPMA) is the primary solvent used to disperse the pigmented ink. Mixtures of DPMA with glycol ethers are also preferred.

The amount of the vehicle in the ink is typically in the range of about 70 to about 99.8 wt %, and preferably about 80 to about 99.8 wt %, based on the total weight of the ink.

The inks may optionally contain one or more other ingredients such as, for example, surfactants, binders, bactericides, fungicides, algicides, sequestering agents, buffering agents, corrosion inhibitors, light stabilizers, anti-curl agents, thickeners, and/or other additives and adjuvants well know within the relevant art. These other ingredients may be formulated into the inks and used in accordance with this invention, to the extent that such other ingredients do not interfere with the stability and jetability of the ink, which may be readily determined by routine experimentation. The inks may be adapted by these additives to the requirements of a particular inkjet printer to provide an appropriate balance of properties such as, for example, viscosity and surface tension, and/or may be used to improve various properties or functions of the inks as needed. The amount of each ingredient must be properly determined, but is typically in the range of 0 to about 15 wt % and more typically 0 to about 10 wt %, based on the total weight of the ink.

Surfactants may be used and useful examples include ethoxylated acetylene diols, ethoxylated primary and secondary alcohols, sulfosuccinates, organosilicones and fluoro surfactants. Surfactants, if used, are typically in the amount of about 0.01 to about 5 wt % and preferably about 0.2 to about 2 wt %, based on the total weight of the ink.

Binders may also be used and can be soluble or dispersed polymer(s) added to the ink to improve the adhesion of a pigment. Examples of polymers that can be used include, for example, polyesters, polystyrene/acrylates, sulfonated polyesters, polyurethanes, polyimides, polyvinyl pyrrolidone/vinyl acetate (PVP/VA), polyvinyl pyrrolidone (PVP), and the like and mixtures thereof. Other binders are conventionally known and can be used herein. When present, binders are used at levels of at least about 0.3 wt %, preferably at least about 0.6 wt % based on the total weight of the ink. The upper limits are dictated by ink viscosity or other physical limitations.

In a preferred embodiment, the ink is UV curable. UV curable inksets provide the desirability of being less sensitive to interlayer sheet components, providing long term stability of the image. They further reduce or eliminate the need for special treatments or coatings to the image-bearing layer prior to the application of the image to enhance the ink receptiveness. The solvents may also be comprised in part, or entirely, of polymerizable solvents, such as solvents which cure upon application of actinic radiation (actinic radiation curable) or UV light (UV curable). Specific examples of the radically polymerizable monomers and oligomers which may serve a components within such reactive solvent systems include, for example; vinyl monomers(meth)acrylate esters, styrene, vinyltoluene, chlorostyrene, bromostyrene, vinyl acetate, N-vinylpyrrolidone(meth)acrylonitrile, allyl alcohol, maleic acid, maleic anhydride, maleimide, N-methylmaleimide(meth)acrylic acid, itaconic acid, polyethylene glycol mono(meth)acrylate, glycidyl(meth)acrylate, ethylene glycol di(meth)acrylate, trimethylolpropane tri(meth)acrylate, mono(2-(meth)acryloyloxyethyl)acid phosphate, prepolymers having at least one (meth)acryloyl group, polyester(meth)acrylates, polyurethane(meth)acrylates, epoxy(meth)acrylates, polyether(meth)acrylates, oligo(meth)acrylates, alkyd(meth)acrylates, polyol(meth)acrylates, unsaturated polyesters, and the like and mixtures thereof. This should not be taken as limiting. Any radically curable monomer system can be used in the invention.

Preferably, the actinic radiation-curable composition contains a minor amount of a photoinitiator which allows the composition to cure by irradiation with a decreased dose of actinic radiation. In addition, an accelerator (sensitizer), such as an amine-type compound, for example, may also be used. Photo-cationic polymerization initiators, as described below, may also be used. One or more photoinitiators may be added to the composition in a total level of from about 0.1 wt % to about 20 wt % based on the weight of total coating composition.

The image-bearing (decorated) film layer is irradiated with actinic radiation (UV light or an electron beam) to cure the image on the film layer. The source of actinic radiation may be selected from a low-pressure mercury lamp, high-pressure mercury lamp, metal halide lamp, xenon lamp, excimer laser, and dye laser for UV light, an electron beam accelerator and the like. The dose is usually in the range of 50-3,000 mJ/cm2 for UV light and in the range of 0.2-1,000 mu C/cm2 for electron beams.

Alternatively, the image may be formed from a photo-cationic-curable material. Generally, photo-cationically-curable materials contain epoxide and/or vinyl ether materials. Upon exposure of a photo-generating acid precursor such as a triarylsulfonium salt, a Lewis acid is generated which is capable of polymerizing the epoxy functional and/or vinyl ether functional materials. The compositions may optionally include reactive diluents and solvents. Examples of preferable optional reactive diluents and solvents include epoxide-containing and vinyl ether-containing materials. In the compositions according to the invention, any type of photoinitiator that, upon exposure to actinic radiation, forms cations that initiate the reactions of the epoxy and/or vinyl ether material(s) can be used. There are a large number of known cationic photoinitiators for epoxy and vinyl ether resins within the art that are suitable. They include, for example, onium salts with anions of weak nucleophilicity, halonium salts, iodosyl salts or sulfonium salts, such as are disclosed in EP 153904 and WO 98/28663, sulfoxonium salts, such as disclosed, for example, in EP 35969, EP 44274, EP 54509, and EP 164314, or diazonium salts, such as disclosed, for example, in U.S. Pat. No. 3,708,296 and U.S. Pat. No. 5,002,856. Other cationic photoinitiators are metallocene salts, such as disclosed, for example, in EP 94914 and EP 94915. A survey of other current onium salt initiators and/or metallocene salts can be found in “UV Curing, Science and Technology” (Editor S. P. Pappas, Technology Marketing Corp., 642 Westover Road, Stamford, Conn., U.S.A.) or “Chemistry & Technology of UV & EB Formulation for Coatings, Inks & Paints”, Vol. 3 (edited by P. K. T. Oldring). One or more photo-cationic initiators may be added to the composition in a total level of from about 0.1 wt % to about 20 wt % based on the weight of total coating composition. The image may be cured as described above.

Jet velocity, drop size and stability are greatly affected by the surface tension and the viscosity of the ink. Ink jet inks typically have a surface tension in the range of about 20 dyne/cm to about 60 dyne/cm at 25° C. Viscosity can be as high as 30 cP at 25° C., but is typically somewhat lower. The inks have physical properties compatible with a wide range of ejecting conditions, i.e., driving frequency of the piezo element, or ejection conditions for a thermal head, for either drop-on-demand device or a continuous device, and the shape and size of the nozzle. The ink set should have excellent storage stability for long periods so as not to clog to a significant extent in an ink jet apparatus. Further, it should not alter the materials of construction of the ink jet printing device it comes in contact with, and will be preferably odorless and non-toxic.

It is preferable that the ink (as an aqueous-based, non-aqueous-based, or a mixture of an aqueous-based and non-aqueous-based vehicles) has a sufficiently low viscosity such that they can be jetted through the printing head of an ink jet printer without the necessity of heating the print head in order to lower the viscosity of the ink. It is, therefore, preferable for the ink viscosity to be below about 30 centipoise (cps), as measured at 25° C., more preferably below about 20 cps at 25° C., even more preferably below about 15 cps at 25° C., and most preferably below about 12 cps at 25° C. Preferably, the ink has a viscosity above about 1 cps at 25° C. to provide good image quality. For drop-on-demand ink jet printers, it is preferable that the ink has a viscosity of above about 1.5 cps at 25° C.

The use of digital image manipulation software, such as Adobe's Photoshop® and/or Illustrator®, in combination with the raster image processing (Postershop® RIP) software can provide a completed printing project from design to finished proof in a matter of hours. For example, Adobe® Photoshop® may be used to produce a postscript file. The postscript file may through suitable interfaces be used to provide the necessary data to the printer for reproduction of the image. The Postershop®) RIP software may additionally be used for scaling and color correction before outputting the necessary data to the printer for reproduction of the image.

Any ink jet printer process known may be used to apply the image to the film layer, for example the preferable solar control film of the invention. A specific example of a large format ink jet printer is an MMT paint jet system, (MetroMedia Technologies International, Inc., New York, N.Y.). This printer supports the film layer such as a solar control film on a large rotating drum, which serves to mechanically stabilize the solar control film. This can be achieved by laying the solar control film on the drum and taping the edges of the solar control film to the rotatable drum using, for example, conventional adhesive tape. This attachment to the rotating drum of the printing machine provides sufficient mechanical stabilization of the solar control film to allow accurate printing on the surface as the drum is rotated adjacent to the print head. The solar control film on the drum is held in close proximity to the printing head, which moves in an axial direction in response to the printer control system. The print head is driven in the conventional manner by the printer electronics. This type of printer typically utilizes a solvent based automotive paint. When UV-curable inksets are utilized, the UV curing lamp is generally attached to the printhead(s).

Another ink jet printer design similar to the MMT system described above also utilizes a large drum to support the film layer. This drum in this system is perforated by a series of apertures and a vacuum is applied to the interior of the drum to hold and mechanically stabilize the film layer. This system also provides a supply roll which feeds the film layer to the drum through guide rollers. This system typically utilizes any suitable solvent based pigmented ink. A Vutek® 5300 digital printing machine (Vutek, Foster City, Calif.) operates by passing the film layer to be printed over a series of rollers pass a printhead. The printer holds the film layer to be printed under tension between rollers to provide a stable surface for printing. The film layer can be stabilized with a sacrificial web which passes through the printer with the film layer. The sacrificial web can be fiber-reinforced vinyl, paper or any other material which does not stretch under moderate tension. The film layer can be taped to the sacrificial web. The film layer and the sacrificial web can be fed to this type of printer through a series of rollers and passes in front of the printhead without being stretched or deformed to allow for accurate printing. This type of printer can use a solvent-based pigment.

Flat bed piezoelectric drop-on-demand ink jet printers may also be utilized within the invention. Typically, the printing process is of two general types. In one process, the flat film layer is moved across the printhead(s) during the printing process, generally through the use of rollers or through movement of the entire flatbed that the film layer is immobilized in. In an alternative process, the printhead(s) move across the film layer immobilized in the flat bed. When UV-curable inksets are utilized, the UV curing lamp is generally attached to the printhead(s).

### Adhesion Promoter Coating

In a further embodiment, the image-bearing surface of the image-bearing film layer requires an adhesive or primer layer, regardless of the process utilized to produce the image-bearing layer. Adhesion at the interface of the image and the polymeric interlayer is critical in providing the desirable safety laminates. The adhesive layer preferably can take the form of a monolayer of an adhesive primer or of a coating. While the minimum size can be determined based upon the minimal possible size of a monolayer or coating, it can be as small as about 0.0004 mil (about 0.00001 mm) or possibly even smaller. The adhesive/primer coating can be up to about 1 mil (about 0.03 mm), or preferably, up to about 0.5 mil (about 0.013 mm), or more preferably, up to about 0.1 mil (about 0.003 mm), thick. The adhesive may be any adhesive or primer known within the art. The adhesives and primers are used to enhance the bond strength between the image-bearing surface of the image-bearing film layer and the other laminate layers.

Preferably the adhesion promoter is selected from the group consisting of silane and poly(alkyl amine) adhesion promoters, and mixtures thereof. In one preferred embodiment, the adhesion promoter is an aminosilane. In another preferred embodiment, the adhesion promoter is selected from the group consisting of poly(vinyl amine), poly(allyl amine) and mixtures thereof. Preferably, the primer or adhesive is selected from vinyltriethoxysilane, vinyltrimethoxysilane, vinyltris(beta-methoxyethoxy)silane, gamma-methacryloxypropyltrimethoxysilane, beta-(3,4-epoxycyclohexyl)ethyltrimethoxysilane, gamma-glycidoxypropyltrimethoxysilane, gamma-glycidoxypropylmethyldiethoxysilane, vinyl-triacetoxysilane, gamma-mercaptopropyltrimethoxysilane, (3-aminopropyl)trimethoxysilane, (3-aminopropyl)triethoxysilane, N-beta-(aminoethyl)-gamma-aminopropyl-trimethoxysilane, N-(beta-aminoethyl) gamma-aminopropylmethyldimethoxysilane, aminoethylaminopropyl silane triol homopolymer, vinylbenzylaminoethylaminopropyltrimethoxysilane, bis(trimethoxysilylpropyl)amine, poly(vinyl amine), poly(allyl amine) and the like, and mixtures thereof.

More preferably, the adhesive or primer contains an amine function. Specific examples of such materials include, for example; (3-aminopropyl)trimethoxysilane, (3-aminopropyl)triethoxysilane, N-beta-(aminoethyl)-gamma-aminopropyl-trimethoxysilane, N-(beta-aminoethyl) gamma-aminopropylmethyldimethoxysilane, aminoethylaminopropyl silane trio homopolymer, vinylbenzylaminoethylaminopropyltrimethoxysilane, bis(trimethoxysilylpropyl)amine, poly(vinyl amine), poly(allyl amine) and the like and mixtures thereof. This should not be taken as limiting. Essentially any known primer or adhesive within the art can find utility within the invention. Commercial examples of such materials include, for Dow Corning Z 6011 Silane (Dow Corning Corporation, Midland, Mich.) and SILQUEST A-1100 silane and A-1102 silane (GE Silicones, Friendly, W.Va.), believed to be (3-aminopropyl)triethoxysilane, Dow Corning Z 6020 Silane (Dow Corning), and SILQUEST A-1120 silane, (GE Silicones) believed to be N-beta-(aminoethyl)-gamma-aminopropyl-trimethoxysilane, SILQUEST A-2120 silane (GE Silicones), believed to be N-(beta-aminoethyl) gamma-aminopropylmethyldimethoxysilane, Dow Corning Z 6137 Silane (Dow Corning), believed to be aminoethylaminopropyl silane triol homopolymer, Dow Corning Z 6040 Silane (Dow Corning), and SILQUESTA-187 silane (GE Silicones), believed to be gamma-glycidoxypropyltrimethoxysilane, Dow Corning Z 6130 Silane (Dow Corning), believed to be methacryloxypropyltrimethoxysilane, Dow Corning Z 6132 Silane (Dow Corning), believed to be vinylbenzylaminoethylaminopropyltrimethoxysilane, Dow Corning Z 6142 Silane (Dow Corning), believed to be gamma-glycidoxypropylmethyldiethoxysilane, Dow Corning Z 6075 Silane (Dow Corning), believed to be vinyltriacetoxysilane, Dow Corning Z 6172 Silane (Dow Corning), and SILQUEST A-172 silane (GE Silicones), believed to be vinyl tris(methoxyethoxy)silane, Dow Corning Z 6300 Silane (Dow Corning), and SILQUEST A-171 silane (GE Silicones), believed to be vinyltrimethoxysilane, Dow Corning Z 6518 Silane (Dow Corning), and SILQUEST A-151 silane (GE Silicones), believed to be vinyltriethoxysilane, and SILQUEST A-1170 silane (GE Silicones), believed to be bis(trimethoxysilylpropyl)amine and Lupamin® 9095 (BASF Corporation, Florham Park, N.J., believed to be poly(vinyl amine)). These materials have been found to provide adequate adhesion between the image-bearing layer surface and the other laminate layers, such as the interlayer.

Even more preferably, the adhesive or primer is a polyolefin with primary amine functionality, such as poly(vinyl amine), poly(allyl amine) and the like. Such adhesives and primers have been found to provide even higher levels of adhesion between the image-bearing surface of the image-bearing film layer and the other laminate layers, such as the interlayer, which is, desirable to provide the highest level of safety attributes to the laminates.

The adhesives may be applied through melt processes or through solution, emulsion, dispersion, and the like, coating processes. One of ordinary skill in the art will be able to identify appropriate process parameters based on the composition and process used for the coating formation. The above process conditions and parameters for making coatings by any method in the art are easily determined by a skilled artisan for any given composition and desired application. For example, the adhesive or primer composition can be cast, sprayed, air knifed, brushed, rolled, poured or printed or the like onto the image-bearing film layer surface. Generally the adhesive or primer is diluted into a liquid medium prior to application to provide uniform coverage over the image-bearing surface. The liquid media may function as a solvent for the adhesive or primer to form solutions or may function as a non-solvent for the adhesive or primer to form dispersions or emulsions. Coatings may also be applied by spraying.

In a further embodiment, image-bearing (e.g., decorated) safety laminates are provided which include at least one image-bearing film layer and at least one polymeric interlayer sheet, preferably with a laminate adhesive strength of at least about 1000 psi. In order for the image-bearing safety laminates to function as is commonly assumed for safety laminates, the laminate adhesive strength must be sufficient to avoid delamination. The laminate adhesive strength may be measured by any known test method, for example, through peel testing as described within WO 99/58334. Preferably, the image-bearing safety laminates which include at least one image-bearing film layer and at least one polymeric interlayer sheet have a laminate adhesive strength of at least about 2000 psi, more preferably at least about 3000 psi, and even more preferably at least about 4000 psi.

### Ionomeric Interlayer Sheet

The laminated articles of this invention contain at least one ionomeric interlayer sheet bound to the image-bearing film layer by the adhesion promoter. While the invention is focused on printing on the film layer, the ionomeric interlayer sheet may also contain an image. (In one preferred embodiment the ionomeric interlayer sheet contains an image and in another preferred embodiment it doesn't). When the ionomeric interlayer sheet contains an image, it is preferably applied through an ink jet printing process.

Within the present invention, the image-bearing side of the image-bearing film layer is in contact with the ionomeric interlayer to prevent the image from environmental degradation and therefore providing high level of stability to the image. By embedding the image, it further protects the image from degradation through routine cleaning and the like.

In accordance to the invention, the ionomeric copolymer that is used to form the ionomeric interlayer is derived from certain parent acid copolymer of an alpha olefin and about 15 to about 30 wt % of an alpha, beta-ethylenically unsaturated carboxylic acid having 3 to 8 carbons, based on the total weight of the copolymer. Preferably, the parent acid copolymer used herein is made from about 18 to about 25 wt %, or more preferably, about 18 to about 23 wt %, of the alpha, beta-ethylenically unsaturated carboxylic acid, based on the total weight of the copolymer.

The alpha olefin comonomers used herein typically incorporate from 2 to 10 carbon atoms. Preferable alpha olefins include, but are not limited to, ethylene, propylene, 1-butene, 1-pentene, 1-hexene, 1-heptene, 3 methyl-1-butene, 4-methyl-1-pentene and the like and mixtures thereof. More preferably, the alpha olefin is ethylene. The alpha, beta-ethylenically unsaturated carboxylic acid comonomers may include acrylic acid, methacrylic acid, itaconic acid, maleic acid, maleic anhydride, fumaric acid, monomethyl maleic acid and mixtures thereof. Preferable alpha, beta-ethylenically unsaturated carboxylic acid comonomers include acrylic acid, methacrylic acid and mixtures thereof.

The parent acid copolymers used herein preferably have a melt index (MI) of about 20 to about 60 grams/10 min as measured by ASTM D1238 at 190° C. using a 2160 g. (A similar ISO test is ISO 1133.) More preferably, the parent acid copolymer has a MI of about 20 to about 50 grams/10 min, even more preferably has a MI of about 20 to about 40 grams/10 min, and most preferably has a MI of about 20 to about 30 grams/10 min. The ionomer copolymers of the present invention exhibit improved toughness relative to what would be expected for similar ionomer copolymers when they are derived from the lower MI acid copolymers of the invention. This is especially desirable since the ionomer copolymers of the present invention are utilized within the interlayers and safety laminates of the invention, as described below.

The parent acid copolymers used herein may be polymerized as disclosed in U.S. Pat. No. 3,404,134; U.S. Pat. No. 5,028,674; U.S. Pat. No. 6,500,888; and U.S. Pat. No. 6,518,365.

To produce the ionomer copolymers disclosed herein, the parent acid copolymers are neutralized from about 5 to about 90%, or preferably, from about 10 to about 50%, or more preferably, from about 20 to about 40%, with metallic ions, based on the total carboxylic acid content. The metallic ions used herein may be monovalent, divalent, trivalent, multivalent, or mixtures therefrom. Useful monovalent metallic ions include, but are not limited to, sodium, potassium, lithium, silver, mercury, copper and the like and mixtures thereof. Useful divalent metallic ions include, but are not limited to, beryllium, magnesium, calcium, strontium, barium, copper, cadmium, mercury, tin, lead, iron, cobalt, nickel, zinc and the like and mixtures therefrom. Useful trivalent metallic ions include, but are not limited to, aluminum, scandium, iron, yttrium and the like and mixtures therefrom. Useful multivalent metallic ions include, but are not limited to, titanium, zirconium, hafnium, vanadium, tantalum, tungsten, chromium, cerium, iron and the like and mixtures therefrom. It is noted that when the metallic ion is multivalent, complexing agents, such as stearate, oleate, salicylate, and phenolate radicals are included, as disclosed within U.S. Pat. No. 3,404,134. The metallic ions used herein are preferably monovalent or divalent metallic ions. More preferably, the metallic ions used herein are selected from the group consisting of sodium, lithium, magnesium, zinc and mixtures therefrom. Yet more preferably, the metallic ions used herein are selected from the group consisting of sodium, zinc and mixtures therefrom. The parent acid copolymers of the invention may be neutralized as disclosed in U.S. Pat. No. 3,404,134.

The ionomer copolymers used herein may optionally contain other unsaturated comonomers. Specific examples of preferable other unsaturated comonomers include, but are not limited to, methyl acrylate, methyl methacrylate, ethyl acrylate, ethyl methacrylate, isopropyl acrylate, isopropyl methacrylate, butyl acrylate, butyl methacrylate and mixtures thereof. In general, the ionomeric copolymers used herein may incorporate 0 to about 50 wt %, or preferably, 0 to about 30 wt %, or more preferably, 0 to about 20 wt %, of the other unsaturated comonomer(s), based on the total weight of the copolymer.

The ionomeric interlayer sheet preferably has a total thickness of about 10 to about 250 mils (about 0.25-about 6.35 mm), or more preferably, about 15 to about 90 mils (about 0.38-about 2.28 mm), or most preferably, about 30 to about 60 mils (about 0.76-about 1.52 mm) to ensure adequate penetration resistance commonly regarded as a feature of safety laminates.

The ionomeric interlayer sheets may be formed by any process known in the art, such as extrusion, calendering, solution casting or injection molding. The parameters for each of these processes can be easily determined by one of ordinary skill in the art depending upon viscosity characteristics of the polymeric material and the desired thickness of the sheet.

The ionomeric interlayer sheet is preferably formed by extrusion.

The ionomeric interlayer sheet may be combined with other polymeric materials during extrusion and/or finishing to form laminates or multilayer sheets with improved characteristics. A multilayer or laminate sheet may be made by any method known in the art, and may have as many as five or more separate layers joined together by heat, adhesive and/or tie layer, as known in the art. One of ordinary skill in the art will be able to identify appropriate process parameters based on the polymeric composition and process used for sheet formation.

The interlayer sheet properties may be further adjusted by adding certain additives and fillers to the polymeric composition, such as colorants, dyes, plasticizers, lubricants antiblock agents, slip agents, and the like. The interlayer sheets of the invention may be further modified to provide valuable attributes to the sheets and to the laminates produced therefrom. For example, the sheets may be treated by radiation, for example E-beam treatment of the sheets. E-beam treatment of the and sheets of the invention with an intensity in the range of about 2 MRd to about 20 MRd will provide an increase in the softening point of the sheet (Vicat Softening Point) of about 20° C. to about 50° C. Preferably, the radiation intensity is from about 2.5 MRd to about 15 MRd.

It is understood that the ionomeric compositions may include additives known within the art. The additives may include, for example, plasticizers, processing aides, flow enhancing additives, lubricants, pigments, dyes, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like. For example, typical colorants may include a bluing agent to reduce yellowing, a colorant may be added to color the laminate or control solar light. The compositions can contain infrared absorbents, such as inorganic infrared absorbents, for example indium tin oxide nanoparticles and antimony tin oxide nanoparticles, and organic infrared absorbents, for example polymethine dyes, amminium dyes, imminium dyes, dithiolene-type dyes and phthalocyanine-type dyes and pigments.

The ionomeric compositions can contain an effective amount of a thermal stabilizer. Thermal stabilizers are well disclosed within the art. Any known thermal stabilizer will find utility. Preferable general classes of thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O—, N— and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. This should not be considered limiting. Essentially any thermal stabilizer known within the art can be used. The compositions preferably incorporate from 0 to about 1.0 wt % thermal stabilizers, based on the total weight of the composition.

The ionomeric compositions can contain an effective amount of UV absorber(s). UV absorbers are well disclosed within the art. Any known UV absorber can be used. Preferable general classes of UV absorbers include benzotriazoles, hydroxybenzophenones, hydroxyphenyl triazines, esters of substituted and unsubstituted benzoic acids, and the like and mixtures thereof. This should not be considered limiting. Essentially any UV absorber known within the art can be used. The compositions preferably contain from 0 to about 1.0 wt % UV absorbers, based on the total weight of the composition.

The ionomeric compositions may contain an effective amount of hindered amine light stabilizers (HALS). Hindered amine light stabilizers (HALS) are generally well disclosed within the art. Generally, hindered amine light stabilizers are disclosed to be secondary, tertiary, acetylated, N hydrocarbyloxy substituted, hydroxy substituted N-hydrocarbyloxy substituted, or other substituted cyclic amines which further contain steric hindrance, generally derived from aliphatic substitution on the carbon atoms adjacent to the amine function. This should not be considered limiting. Essentially any hindered amine light stabilizer known within the art can be used. The compositions preferably contain from 0 to about 1.0 wt % hindered amine light stabilizers, based on the total weight of the composition.

### Laminates

The laminates may optionally include additional layers, such as other polymeric sheets, other uncoated polymeric films, such as additional layers of film (e.g., biaxially oriented poly(ethylene terephthalate) film), and other coated polymeric films. The “additional layer” polymeric film and sheets may provide additional attributes, such as acoustical barriers, added penetration resistance and the like. Preferably, the “additional layers” polymeric film or sheet is selected from the group consisting of polycarbonate, polyurethane, acrylic sheets, polymethylmethacrylate, polyvinyl chloride, polyester, poly(ethylene-co-(meth)acrylic acid) ionomers and biaxially oriented poly(ethylene terephthalate). The polymeric films and sheets may additionally have functional coatings applied to them, such as organic infrared absorbers and sputtered metal layers, such as silver, coatings and the like. Adhesives or primers may be included, especially to provide adequate adhesion between the other polymeric layer and the interlayer, as described above.

The laminates may additionally contain one or more rigid sheet layers. The rigid sheet layer may be selected from the group consisting of glass or rigid transparent plastic sheets, such as, for example, polycarbonate, acrylics, polyacrylate, poly(methyl methacrylate), cyclic polyolefins, such as ethylene norbornene polymers, polystyrene (preferably metallocene-catalyzed) and the like and combinations thereof. Preferably, the rigid sheet layer comprises a material with a modulus of about 100,000 psi (690 MPa) or greater (as measured by ASTM Method D-638). Preferably the rigid sheet layer is selected from the group consisting of glass, polycarbonate, poly(methyl methacrylate), and combinations thereof. More preferably, the rigid sheet layer is a glass sheet.

The term “glass” is meant to include not only window glass, plate glass, silicate glass, sheet glass, low iron glass, and float glass, but also includes colored glass, specialty glass which includes ingredients to control, for example, solar heating, coated glass with, for example, sputtered metals, such as silver or indium tin oxide, for solar control purposes, E-glass, Toroglass, Solex® glass (PPG Industries, Pittsburgh, Pa.) and the like. Such specialty glasses are disclosed in, for example, U.S. Pat. No. 4,615,989, U.S. Pat. No. 5,173,212, U.S. Pat. No. 5,264,286, U.S. Pat. No. 6,150,028, U.S. Pat. No. 6,340,646, U.S. Pat. No. 6,461,736, and U.S. Pat. No. 6,468,934. The glass may also include frosted or etched glass sheet. Frosted and etched glass sheets are articles of commerce and are well disclosed within the common art and literature. The type of glass to be selected for a particular laminate depends on the intended use.

Metal or ceramic plates may be substituted for the rigid polymeric sheet or glass if clarity is not required for the laminate. Adhesives and primers may be used to enhance the bond strength between the laminate layers, if desired. The adhesives and primers and the processes to apply them can be as described above.

Preferable representative safety laminate examples include:
glass/ionomer interlayer/image-bearing solar control film/ionomer interlayer/glass;
glass/ionomer interlayer/image-bearing solar control film/ionomer interlayer/poly(allyl amine)-primed, biaxially-oriented poly(ethylene terephthalate) film (PET);
glass/ionomer interlayer/PET film with images on both surfaces/ionomer interlayer/glass;
glass/ionomer interlayer/image-bearing PET film;
glass/ionomer interlayer/image-bearing solar control film;
glass/ionomer interlayer/image-bearing PET film/ionomer interlayer/glass;
glass/ionomer interlayer/image-bearing solar control film/ionomer interlayer/image-bearing solar control film/ionomer interlayer/glass;
Glass/ionomer interlayer/image-bearing PET film/ionomer interlayer/PET;
   and the like, wherein the image-bearing film and solar-control film comprises an image formed from an UV-curable inkset through an ink jet process or other image-bearing film layers such as described herein, the image-bearing surface has been primed with poly(allyl amine), poly(vinyl amine), aminosilane or another adhesion promoter, and the image-bearing surface of the image-bearing film and solar control film is in contact with the interlayer, as described above.

The laminates can be produced through autoclave and non-autoclave processes, as described below.

The following describes a specific example for the preparation a glass/ionomer interlayer/image-bearing solar control film/ionomer interlayer/glass laminate through an autoclave process. The laminate can be formed by conventional autoclave processes known within the art. In a typical process, a first glass sheet, a first ionomer interlayer, an image-bearing solar control film, a second ionomer interlayer and a second glass sheet are laminated together under heat and pressure and a vacuum (for example, in the range of about 27-28 inches (689-711 mm) Hg), to remove air. Preferably, the glass sheet has been washed and dried. A typical glass type is 90 mil thick annealed flat glass. In a typical procedure, the interlayers are positioned between the image-bearing solar control film and the glass plates to form a glass/interlayer/image-bearing solar control film/interlayer/glass assembly, placing the assembly into a bag capable of sustaining a vacuum (“a vacuum bag”), drawing the air out of the bag using a vacuum line or other means of pulling a vacuum on the bag, sealing the bag while maintaining the vacuum, placing the sealed bag in an autoclave at a temperature of about 130° C. to about 180° C., at a pressure of about 150 psi (11.3 bar) to about 250 psi (18.8 bar), for from about 10 to about 50 minutes. Preferably the bag is autoclaved at a temperature of from about 120° C. to about 160° C. for 20 minutes to about 45 minutes. More preferably the bag is autoclaved at a temperature of from about 135° C. to about 160° C. for 20 minutes to about 40 minutes. Most preferably the bag is autoclaved at a temperature of from about 145° C. to about 155° C. for 25 minutes to about 35 minutes. A vacuum ring may be substituted for the vacuum bag. One type of vacuum bag is disclosed within U.S. Pat. No. 3,311,517.

Alternatively, other processes may be used to produce the laminates. Any air trapped within the glass/interlayer/image-bearing solar control film/interlayer/glass assembly may be removed through a nip roll process. For example, the glass/interlayer/image-bearing solar control film/interlayer/glass assembly may be heated in an oven at about 80 to about 120° C., preferably about 90 to about 100° C., for about 20 minutes to about 40 minutes. Thereafter, the heated glass/interlayer/image-bearing solar control film/interlayer/glass assembly is passed through a set of nip rolls so that the air in the void spaces between the glass and the interlayer may be squeezed out, and the edge of the assembly sealed. The assembly at this stage is referred to as a pre-press.

The pre-press assembly may then placed in an air autoclave where the temperature is raised to about 120° C. to about 160° C., preferably about 135° C. to about 160° C., and pressure of about 100 psig to about 300 psig, preferably about 200 psig (14.3 bar). These conditions are maintained for about 15 minutes to about 1 hour, preferably about 20 minutes to about 50 minutes, after which, the air is cooled while no more air is added to the autoclave. After about 20 minutes to about 40 minutes of cooling, the excess air pressure is vented and the laminates are removed from the autoclave. This should not be considered limiting. Essentially any lamination process known within the art may be used with the interlayers.

The laminates can also be produced through non-autoclave processes. Such non-autoclave processes are disclosed, for example, within U.S. Pat. No. 3,234,062, U.S. Pat. No. 3,852,136, U.S. Pat. No. 4,341,576, U.S. Pat. No. 4,385,951, U.S. Pat. No. 4,398,979, U.S. Pat. No. 5,536,347, U.S. Pat. No. 5,853.,516, U.S. Pat. No. 6,342,116, U.S. Pat. No. 5,415,909, US 2004/0182493, EP 1 235 683 B1, WO 91/01880 and WO 03/057478 A1. Generally, the non-autoclave processes include heating the pre-press assembly and the application of vacuum, pressure or both. For example, the pre-press may be successively passed through heating ovens and nip rolls.

### EXAMPLES

### Example 1

An ink set is used which included the following ink formulations; Magenta (36.08 wt % of a magenta pigment dispersion (7 wt % pigment), 38.35 wt % DOWANOL DPMA (Dow Chemical Company), and 25.57 wt % DOWANOL DPnP (Dow Chemical Company) (based on the total weight of the ink formulation); Yellow (35.23 wt % of a yellow pigment dispersion (7 wt % pigment), 38.86 wt % DOWANOL DPMA, and 25.91 wt % DOWANOL DPnP (based on the total weight of the ink formulation); Cyan (28.35 wt % of a cyan pigment dispersion (5.5 wt % pigment), 42.99 wt % DOWANOL DPMA, and 28.66 wt % DOWANOL DPM (Dow Chemical Company), (based on the total weight of the ink formulation); and Black (27.43 wt % of a black pigment dispersion (7 wt % pigment), 43.54 wt % DOWANOL DPMA, and 29.03 wt % DOWANOL DPM (based on the total weight of the ink formulation). The pigment dispersion compositions and preparations are as disclosed within the Example section of U.S. Pat. No. 7,041,163.

Using the above mentioned ink set, a 4 mils thick (0.10 mm) surface flame-treated biaxially oriented poly(ethylene terephthalate) (PET) film is ink jet printed with an image with an Epson 3000 printer to provide an ink coverage of 125%.

A solution of SILQUEST A-1100 silane (0.05 wt % based on the total weight of the solution) (GE Silicones) (believed to be gamma-aminopropyltrimethoxysilane), isopropanol (66.63 wt % based on the total weight of the solution), and water (33.32 wt % based on the total weight of the solution) is prepared and allowed to sit for at least one hour prior to use. A 12-inch by 12-inch piece of the image-bearing PET film is dipped into the silane solution (residence time of about 1 minute) removed and allowed to drain and dry under ambient conditions.

A glass laminate composed of a glass layer, a SentryGlas® Plus SGP5000 interlayer (DuPont) the silane-primed image-bearing PET film, a second SentryGlas® Plus SGP5000 interlayer and a glass layer is produced in the following manner. The primed image-bearing PET film (12 inches by 12 inches (305 mm×305 mm)) and the SentryGlas® Plus SGP5000 sheets (12 inches by 12 inches (305 mm×305 mm) by 40 mils (1.02 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), a SentryGlas® Plus SGP5000 interlayer, the silane-primed image-bearing PET film layer, a SentryGlas® Plus SGP5000 interlayer and a clear annealed float glass plate layer (12 inches by 12 inches (305 mm×305 mm) by 2.5 mm thick). The glass/interlayer/image-bearing PET film/interlayer/glass assembly is then placed into a vacuum bag and heated to 90-100° C. for 30 minutes to remove any air contained between the glass/interlayer/image-bearing PET film/interlayer/glass assembly. The glass/interlayer/image-bearing PET film/interlayer/glass pre-press assembly is then subjected to autoclaving at 135° C. for 30 minutes in an air autoclave to a pressure of 200 psig (14.3 bar) as described above. The air is then cooled while no more air is added to the autoclave. After 20 minutes of cooling when the air temperature is less than about 50° C., the excess pressure is vented, and the glass/interlayer/image-bearing PET film/interlayer/glass laminate is removed from the autoclave.

### Example 2

A 7 mils thick (0.18 mm) poly(allyl amine)-primed biaxially-oriented poly(ethylene terephthalate) film is ink jet printed with an image with a NUR TEMPO Modular Flatbed Inkjet Press (NUR Microprinters, Monnachie, N.J.) equipped with a UV curing lamp on the print heads and utilizing a pigmented 4-color CMYK UV-curable inkset available from NUR Microprinters to provide an ink coverage of 250%.

The image-bearing surface is coated with a 0.5 wt % aqueous solution of poly(vinyl amine) with a #8 casting rod and is dried under ambient conditions. A glass laminate composed of a glass layer, a SentryGlas® Plus SGP5000 interlayer (DuPont), the primed, image-bearing film, a second SentryGlas® Plus SGP5000 interlayer and a glass layer is produced in the following manner. The primed, image-bearing film (12 inches by 12 inches (305 mm×305 mm)) and the SentryGlas® Plus SGP5000 interlayers (12 inches by 12 inches (305 mm×305 mm) by 60 mils (1.50 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), a SentryGlas® Plus SGP5000 interlayer, the primed, image-bearing film layer, a SentryGlas® Plus SGP5000 interlayer and a clear annealed float glass plate layer (12 inches by 12 inches (305 mm×305 mm) by 2.5 mm thick). The glass/interlayer/image-bearing film/interlayer/glass assembly is then laminated as described for Example 1.

### Example 3

A 4 mils thick (0.10 mm) surface flame-treated biaxially oriented poly(ethylene terephthalate) film (PET) is ink jet printed with an image with a NUR TEMPO Modular Flatbed Inkjet Press (NUR Microprinters, Monnachie, N.J.) equipped with a UV curing lamp on the print heads and utilizing a pigmented 6-color CMYK+lclm UV-curable inkset and a UV-curable white ink available from NUR Microprinters to provide an ink coverage of 500%.

A solution of SILQUEST A-1100 silane (0.025 wt % based on the total weight of the solution) (GE Silicones) (believed to be gamma-aminopropyltrimethoxysilane), isopropanol (66.65 wt % based on the total weight of the solution), and water (33.32 wt % based on the total weight of the solution) is prepared and allowed to sit for at least one hour prior to use. A 12-inch by 12-inch piece of the image-bearing PET film is dipped into the silane solution (residence time of about 1 minute), removed and allowed to drain and dry under ambient conditions.

A glass laminate composed of a glass layer, a SentryGlas® Plus SGP5000 interlayer (DuPont) and the silane-primed, image-bearing PET film is produced in the following manner. The SentryGlas® Plus SGP5000 interlayer (12 inches by 12 inches (305 mm×305 mm) by 90 mils (2.25 mm) thick) and the silane-primed, image-bearing PET film (12 inches by 12 inches (305 mm×305 mm)) are conditioned at 23% relative humidity (RH) at a temperature of 72° F. overnight. The sample is laid up with a clear annealed float glass plate layer (12 inches by 12 inches (305 mm×305 mm) by 3 mm thick), the SentryGlas® Plus SGP5000 interlayer, the silane-primed, image-bearing PET film layer (with the silane-primed, image-bearing surface of the film in contact with the SentryGlas® Plus SGP5000 interlayer), a thin Teflon® film layer (12 inches by 12 inches (305 mm×305 mm)) (DuPont) and an annealed float glass cover layer (12 inches by 12 inches (305 mm×305 mm) by 2.5 mm thick). The glass/interlayer/image-bearing film/Teflon®) film/glass assembly is then laminated as described for Example 1. Removal of the glass cover sheet and the thin Teflon® film provides the glass/SentryGlas® Plus SGP5000 interlayer/image-bearing polyester film laminate of the invention.

### Example 4

Using the above mentioned ink set of Example 1, a 4 mil (0.10 mm) thick poly(allyl amine)-primed, biaxially-oriented poly(ethylene terephthalate) film is ink jet printed with an image with an Epson 3000 printer to provide an ink coverage of 225%.

The image-bearing surface is coated with a 0.5 wt % aqueous solution of poly(vinyl amine) with a #8 casting rod and is dried under ambient conditions. A glass laminate composed of a glass layer, a SentryGlas® Plus SGP5000 interlayer (DuPont), the primed, image-bearing biaxially-oriented film, a second SentryGlas® Plus SGP5000 interlayer and a glass layer is produced in the following manner. The primed, image-bearing film (12 inches by 12 inches (305 mm×305 mm)) and the SentryGlas® Plus SGP5000 interlayers (12 inches by 12 inches (305 mm×305 mm) by 40 mils (1.02 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), a SentryGlas® Plus SGP5000 interlayer, the primed, image-bearing film layer, a SentryGlas® Plus SGP5000 interlayer and a clear annealed float glass plate layer (12 inches by 12 inches (305 mm×305 mm) by 2.5 mm thick). The glass/interlayer/image-bearing film/interlayer/glass assembly is then laminated as described in Example 1.

### Example 5

Using the above mentioned ink set of Example 1, a 2 mils (0.05 mm) thick XIR®-70 HP Auto film (a product of the Southwall Company, Palo Alto, Calif.) ink jet printed on the metallized film surface with an image with an Epson 3000 printer to provide an ink coverage of 100%.

A solution of SILQUEST A-1100 silane (0.05 wt % based on the total weight of the solution) (GE Silicones) (believed to be gamma-aminopropyltrimethoxysilane), isopropanol (66.63 wt % based on the total weight of the solution), and water (33.32 wt % based on the total weight of the solution) is prepared and allowed to sit for at least one hour prior to use. A 12-inch by 12-inch piece of the image-bearing XIR®-70 Auto film is dipped into the silane solution (residence time of about 1 minute) removed and allowed to drain and dry under ambient conditions.

A glass laminate composed of a glass layer, a SentryGlas® Plus SGP5000 interlayer (DuPont) and the decorated XIR®-70 HP Auto film is produced in the following manner. The SentryGlas® Plus SGP5000 interlayer (12 inches by 12 inches (305 mm×305 mm) by 120 mils (3.05 mm) thick) and the silane-primed, image-bearing XIR®-70 HP Auto film (12 inches by 12 inches (305 mm×305 mm)) are conditioned at 23% relative humidity (RH) at a temperature of 72° F. overnight. The sample is laid up with a clear annealed float glass plate layer (12 inches by 12 inches (305 mm×305 mm) by 3 mm thick), a SentryGlas® Plus SGP5000 interlayer, the silane-primed, image-bearing XIR®-70 HP Auto film layer (with the silane-primed, image-bearing metallized surface of the XIR®-70 HP Auto film in contact with the SentryGlas® Plus SGP5000 interlayer), a thin Teflon® film layer (12 inches by 12 inches (305 mm×305 mm)) (DuPont) and an annealed float glass cover layer (12 inches by 12 inches (305 mm×305 mm) by 2.5 mm thick). The glass/interlayer/image-bearing XIR®-70 HP Auto film/Teflon® film/glass assembly is then laminated as described for Example 1. Removal of the glass cover sheet and the thin Teflon® film provides the glass/interlayer/decorated XIR®-70 HP Auto film laminate of the invention.

### Example 6

A 1.8 mils (0.046 mm) thick XIR®-75 Auto Blue V-1 film (a product of the Southwall Company) is ink jet printed with an image with a NUR TEMPO Modular Flatbed Inkjet Press (NUR Microprinters, Monnachie, N.J.) equipped with a UV curing lamp on the print heads and utilizing a pigmented 4-color CMYK UV-curable inkset available from NUR Microprinters to provide an ink coverage of 350%.

The image-bearing surface is coated with a 0.5 wt % aqueous solution of poly(vinyl amine) with a #8 casting rod and is dried under ambient conditions. A glass laminate composed of a glass layer, a SentryGlas® Plus SGP5000 interlayer (DuPont), the primed, image-bearing XIR®-75 Auto Blue V-1 film, a second SentryGlas® Plus SGP5000 interlayer and a glass layer is produced in the following manner. The primed, image-bearing XIR®-75 Auto Blue V-1 film (12 inches by 12 inches (305 mm×305 mm)) and the SentryGlas® Plus SGP5000 interlayers (12 inches by 12 inches (305 mm×305 mm) by 60 mils (1.50 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), a SentryGlas® Plus SGP5000 interlayer, the primed, image-bearing XIR®-75 Auto Blue V-1 film layer, a SentryGlas® Plus SGP5000 interlayer and a clear annealed float glass plate layer (12 inches by 12 inches (305 mm×305 mm) by 2.5 mm thick). The glass/interlayer/image-bearing film/interlayer/glass assembly is then laminated as described in Example 1.

### Example 7

A Soft Look® UV/IR 25 solar control film (a product of the Tomoegawa Paper Company, Ltd., Tokyo, Japan) is ink jet printed on the coated surface of the solar control film with an image with a NUR TEMPO Modular Flatbed Inkjet Press (NUR Microprinters, Monnachie, N.J.) equipped with a UV curing lamp on the print heads and utilizing a pigmented 6-color CMYK+lclm UV-curable inkset and a UV-curable white ink available from NUR Microprinters to provide an ink coverage of 450%.

A solution of SILQUEST A-1100 silane (0.025 wt % based on the total weight of the solution) (GE Silicones) (believed to be gamma-aminopropyltrimethoxysilane), isopropanol (66.65 wt % based on the total weight of the solution), and water (33.32 wt % based on the total weight of the solution) is prepared and allowed to sit for at least one hour prior to use. A 12-inch by 12-inch piece of the image-bearing Soft Look® UV/IR 25 solar control film is dipped into the silane solution (residence time of about 1 minute), removed and allowed to drain and dry under ambient conditions.

A glass laminate composed of a glass layer, a SentryGlas® Plus SGP5000 interlayer (DuPont) and the silane-primed, image-bearing Soft Look® UV/IR 25 solar control film is produced in the following manner. The SentryGlas® Plus SGP5000 interlayer (12 inches by 12 inches (305 mm×305 mm) by 40 mils (1.02 mm) thick) and the silane-primed, image-bearing Soft Look® UV/IR 25 solar control film (12 inches by 12 inches (305 mm×305 mm)) are conditioned at 23% relative humidity (RH) at a temperature of 72° F. overnight. The sample is laid up with a clear annealed float glass plate layer (12 inches by 12 inches (305 mm×305 mm) by 3 mm thick), a SentryGlas® Plus SGP5000 interlayer, the silane-primed, image-bearing Soft Look® UV/IR 25 solar control film layer (with the silane-primed, image-bearing coated surface of the Soft Look® UV/IR 25 solar control film in contact with the SentryGlas® Plus SGP5000 interlayer), a thin Teflon® film layer (12 inches by 12 inches (305 mm×305 mm)) (DuPont) and an annealed float glass cover layer (12 inches by 12 inches (305 mm×305 mm) by 2.5 mm thick). The glass/interlayer/image-bearing Soft Look® UV/IR 25 solar control film/Teflon® film/glass assembly is then laminated as described for Example 1. Removal of the glass cover sheet and the thin Teflon® film provides the glass/interlayer/image-bearing solar control film laminate of the invention.

### Example 8

Using the above mentioned ink set of Example 1, a 1.8 mils thick (0.046 mm) XIR®-75 Green film (a product of the Southwall Company) is ink jet printed with an image with an Epson 3000 printer to provide an ink coverage of 200%. The image-bearing surface is coated with a 0.5 wt % aqueous solution of poly(vinyl amine) with a #8 casting rod and is dried under ambient conditions.

A glass laminate composed of a glass layer, a SentryGlas® Plus SGP5000 interlayer (DuPont), the primed, image-bearing XIR®-75 Green film, a second SentryGlas® Plus SGP5000 interlayer and a glass layer is produced in the following manner. The SentryGlas® Plus SGP5000 interlayers (12 inches by 12 inches (305 mm×305 mm) by 15 mils (0.38 mm) thick) and the primed, image-bearing XIR®-75 Green film (12 inches by 12 inches (305 mm×305 mm)) are conditioned at 23% relative humidity (RH) at a temperature of 72° F. overnight. The sample is laid up with a clear annealed float glass plate layer (12 inches by 12 inches (305 mm×305 mm) by 2.5 mm thick), a SentryGlas® Plus SGP5000 interlayer, a primed, image-bearing XIR®-75 Green film layer, a SentryGlas® Plus SGP5000 interlayer and a clear annealed float glass plate layer (12 inches by 12 inches (305 mm×305 mm) by 2.5 mm thick). The glass/interlayer/glass assembly is then laminated as described for Example 1.

### Example 9

A Raybarrier® TFK-2583 solar control film (a product of the Sumitomo Osaka Cement Company, Tokyo, Japan) is ink jet printed with an image with a NUR TEMPO Modular Flatbed Inkjet Press (NUR Microprinters, Monnachie, N.J.) equipped with a UV curing lamp on the print heads and utilizing a pigmented 4-color CMYK UV-curable inkset available from NUR Microprinters to provide an ink coverage of 300%.

A solution of SILQUEST A-1100 silane (0.025 wt % based on the total weight of the solution) (GE Silicones) (believed to be gamma-aminopropyltrimethoxysilane), isopropanol (66.65 wt % based on the total weight of the solution), and water (33.32 wt % based on the total weight of the solution) is prepared and allowed to sit for at least one hour prior to use. A 12-inch by 12-inch piece of the image-bearing Raybarrier® TFK-2583 solar control film is dipped into the silane solution (residence time of about 1 minute), removed and allowed to drain and dry under ambient conditions.

A glass laminate composed of a glass layer, a SentryGlas® Plus SGP5000 interlayer (DuPont) and the silane-primed, image-bearing Raybarrier® TFK-2583 solar control film is produced in the following manner. The SentryGlas® Plus SGP5000 interlayer (12 inches by 12 inches (305 mm×305 mm) by 60 mils thick (1.50 mm)) and the silane-primed, image-bearing Raybarrier® TFK-2583 solar control film (12 inches by 12 inches (305 mm×305 mm)) are conditioned at 23% relative humidity (RH) at a temperature of 72° F. overnight. The sample is laid up with a clear annealed float glass plate layer (12 inches by 12 inches (305 mm×305 mm) by 3 mm thick), a SentryGlas® Plus SGP5000 interlayer, the silane-primed, image-bearing Raybarrier® TFK-2583 solar control film layer (with the silane-primed, image-bearing coated surface of the Raybarrier® TFK-2583 solar control film in contact with the SentryGlas® Plus SGP5000 interlayer), a thin Teflon® film layer (12 inches by 12 inches (305 mm×305 mm)) (DuPont), and an annealed float glass cover layer, (12 inches by 12 inches (305 mm×305 mm) by 2.5 mm thick). The glass/interlayer/image-bearing Raybarrier® TFK-2583 film/Teflon® film/glass assembly is then laminated as described for Example 1. Removal of the glass cover sheet and the thin Teflon® film provides the glass/SentryGlas® Plus SGP5000 interlayer/image-bearing RAYBARRIER® TFK-2583 film laminate of the invention.

### Example 10

Using the above mentioned ink set of Example 1, a 1 mil (0.026 mm) thick XIR®-70 HP film (a product of the Southwall Company) is ink jet printed with an image with an Epson 3000 printer to provide an ink coverage of 175%. The image-bearing surface is coated with a 0.5 wt % aqueous solution of poly(vinyl amine) with a #8 casting rod and is dried under ambient conditions. A glass laminate composed of a Solex® green glass layer (PPG Industries, Pittsburgh, Pa.), a SentryGlas® Plus SGP5000 interlayer (DuPont), the primed, image-bearing XIR®-70 HP film, a second SentryGlas® Plus SGP5000 interlayer, and a glass layer is produced in the following manner. The primed, image-bearing XIR®-70 HP film (12 inches by 12 inches (305 mm×305 mm)) and the SentryGlas® Plus SGP5000 interlayers (12 inches by 12 inches (305 mm×305 mm) by 60 mils (1.50 mm) thick) are conditioned at 23% relative humidity (RH) at a temperature of 72° F. overnight. The sample is laid up with a Solex® green glass plate layer (12 inches by 12 inches (305 mm×305 mm) by 2.5 mm thick), a SentryGlas® Plus SGP5000 interlayer, the primed, image-bearing XIR®-70 HP film layer, a SentryGlas® Plus SGP5000 interlayer and a clear annealed float glass plate layer (12 inches by 12 inches (305 mm×305 mm) by 2.5 mm thick). The green glass/interlayer/image-bearing XIR®-70 HP film/interlayer/glass assembly is then laminated as described for Example 1.

We claim:

1. An image-bearing article comprising a film layer bearing an image which is coated on the image-bearing side and over the image with an adhesion promoter and which is adhered by the adhesion promoter to an ionomeric interlayer sheet, wherein the ionomeric interlayer sheet comprises an ionomeric copolymer of an alpha-olefin and about 15 to about 30 wt % of an alpha, beta-ethylenically unsaturated carboxylic acid having 3 to 8 carbons, based on the total weight of the ionomeric copolymer, and wherein about 5% to about 90% of the carboxylic acids in the ionomeric copolymer are neutralized with one or more metal ions.

2. The image-bearing article of claim 1 wherein the article further comprises a rigid sheet adhered to the ionomeric interlayer.

3. The image-bearing article of claim 2 wherein the rigid sheet is a sheet of glass.

4. The image-bearing article of claim 1 wherein the adhesion promoter is selected from the group consisting of silanes and poly(alkyl amine) adhesion promoters, and mixtures thereof.

5. The image-bearing article of claim 4 wherein the adhesion promoter is an aminosilane.

6. The image-bearing article of claim 4 wherein the adhesion promoter is selected from the group consisting of poly(vinyl amine), poly(allyl amine) and mixtures thereof.

7. The image-bearing article of claim 1 wherein the adhesion promoter is selected from the group consisting of vinyltriethoxysilane, vinyltrimethoxysilane, vinyltris(beta-methoxyethoxy)silane, gamma-methacryloxypropyltrimethoxysilane, beta-(3,4-epoxycyclohexyl)ethyltrimethoxysilane, gamma-glycidoxypropyltrimethoxysilane, gamma-glycidoxypropylmethyldiethoxysilane, vinyl-triacetoxysilane, gamma-mercaptopropyltrimethoxysilane, (3-aminopropyl)trimethoxysilane, (3-aminopropyl)triethoxysilane, N-beta-(aminoethyl)-gamma-aminopropyl-trimethoxysilane, N-(beta-aminoethyl)gamma-aminopropylmethyldimethoxysilane, aminoethylaminopropyl silane triol homopolymer, vinylbenzylaminoethylaminopropyltrimethoxysilane, bis(trimethoxysilylpropyl)amine, and mixtures thereof.

8. The image-bearing article of claim 1 wherein the adhesion promoter is selected from the group consisting of (3-aminopropyl)trimethoxysilane, (3-aminopropyl)triethoxysilane, N-beta-(aminoethyl)-gamma-aminopropyl-trimethoxysilane, N-(beta-aminoethyl)gamma-aminopropylmethyldimethoxysilane, aminoethylaminopropyl silane triol homopolymer, vinylbenzylaminoethylaminopropyltrimethoxysilane, bis(trimethoxysilylpropyl)amine, and mixtures thereof.

9. The image-bearing article of claim 1 wherein the adhesion promoter is selected from the group consisting of gamma-aminopropyltriethoxysilane, and N-beta-(aminoethyl)-gamma-aminopropyl-trimethoxysilane and mixtures thereof.

10. The image-bearing article of claim 1 wherein the film layer is a polyester film.

11. The image-bearing article of claim 1 wherein the film layer is a biaxially-oriented, poly(ethylene terephthalate) film.

12. The image-bearing article of claim 3 wherein the film layer is a biaxially-oriented, poly(ethylene terephthalate) film.

13. The image-bearing article of claim 1 wherein the film layer is a solar control film.

14. The image-bearing article of claim 1 wherein the adhesion coating has a thickness of less than 1 mil.

15. The image-bearing article of claim 1 wherein the ionomeric interlayer sheet has a total thickness of about 10 to about 250 mils.

16. The image-bearing article of claim 1 having a laminate adhesive strength of about 1000 psi or greater.

17. The image-bearing article of claim 3 wherein the adhesion coating has a thickness of up to about 1 mil, the ionomeric interlayer has a thickness of about 10 to about 250 mils, and the film has a thickness of about 0.1 mils to about 10 mils.

18. An image-bearing article comprising:
(a) a first rigid sheet selected from the group consisting of glass, poly(carbonate), and poly(methacrylate) sheets and laminated to,
(b) a first ionomeric interlayer sheet comprising a first ionomeric copolymer of an alpha-olefin and about 15 to about 30 wt % of an alpha, beta-ethylenically unsaturated carboxylic acid having 3 to 8 carbons, based on the total weight of the first ionomeric copolymer, and wherein about 5% to about 90% of the carboxylic acids in the first ionomeric copolymer are neutralized with one or more metal ions, which is laminated to,
(c) a film layer having one side bearing an image, wherein an adhesion promoter selected from the group consisting of aminosilane, poly(vinyl amine), poly(allyl amine) and mixtures thereof is coated over the image and directly adhered to the first ionomeric interlayer, and wherein the non-image-bearing side of the film layer is laminated to,
(d) a second ionomeric interlayer sheet comprising a second ionomeric copolymer of an alpha-olefin and about 15 to about 30 wt % of an alpha, beta-ethylenically unsaturated carboxylic acid having 3 to 8 carbons, based on the total weight of the second ionomeric copolymer, and wherein the about 5% to about 90% of the carboxylic acids in the second ionomeric copolymer are neutralized with one or more metal ions, which is laminated to,
(e) a second rigid sheet selected from the group consisting of glass, poly(carbonate), and poly(methacrylate) sheets.

19. The image-bearing article of claim 18 wherein the first and second rigid sheets are glass sheets, and the film layer is a solar control film.

20. A process of preparing an image-bearing article comprising a coated image-bearing film layer:
(a) providing a film layer;
(b) printing an image on the film layer so as to produce an image-bearing film layer containing an image-bearing side;
(c) coating an adhesion promoter on the image-bearing side and over the image to produce the coated image-bearing film layer; and
(d) laminating an ionomeric interlayer sheet to the image-bearing side of the coated image-bearing film layer, wherein the ionomeric interlayer sheet comprises a ionomeric copolymer of an alpha-olefin and about 15 to about 30 wt % of an alpha, beta-ethylenically unsaturated carboxylic acid having 3 to 8 carbons, based on the total weight of the copolymer, and wherein about 5% to about 90% of the carboxylic acids in the ionomeric copolymer are neutralized with one or more metal ions.

21. The process of claim 20 further comprising laminating a rigid sheet to the ionomeric interlayer sheet, wherein the rigid sheet is selected from the group consisting of glass, poly(carbonate), and poly(methacrylate) sheets.

22. The process of claim 21 wherein (i) the rigid sheet is a glass sheet, (ii) the film layer is a solar control film, (iii) the image comprises ink jet printing, (iv) the lamination step (d) includes applying heat and, optionally, pressure, and (v) the adhesion promoter is selected from the group consisting of aminosilane, poly(vinyl amine), poly(allyl amine) and mixtures thereof.
